(19) United States
(12) Patent Application Publication
(10) Pub. No.: US 2018/0132316 A1
(43) Pub. Date: May 10, 2018

(54) INDUCTOR-LESS CHARGE PUMP, POWER SUPPLY APPARATUS AND LED LIGHT BULB SYSTEM

(71) Applicants: Wai Lee, Beaverton, OR (US); Calvin Lee, Beaverton, OR (US)

(72) Inventors: Wai Lee, Beaverton, OR (US); Calvin Lee, Beaverton, OR (US)

(73) Assignee: ASP Technologies, Austin, TX (US)

(21) Appl. No.: 15/346,399

(22) Filed: Nov. 8, 2016

(51) Int. Cl. H05B 33/08

(52) U.S. Cl. CPC H05B 33/0812; H05B 33/0845

(57) ABSTRACT

An inductor-less LED power supply apparatus and method are disclosed which includes a charge pump and current driver.

### CROSS-REFERENCE TO RELATED APPLICATION

The Applicants claim the benefit of the earlier provisional patent application, U.S. Patent Application Ser. No. 62/252695, filed 9 Nov. 2015, and entitled INDUCTOR-LESS CHARGE PUMP, POWER SUPPLY APPARATUS AND LED LIGHT BULB SYSTEM. The entire content of this provisional patent application is incorporated herein by this reference.

### FIELD OF THE INVENTION

This invention relates to LED (light-emitting diode) charge pumps, power supplies, and light bulbs, light bulb systems, and associated methods. More particularly, the invention relates to inductor-less LED charge pumps, power supplies and related LED light bulb devices and systems.

### BACKGROUND

New government lighting efficiency standards are making the incandescent light bulb obsolete. The movement to higher lighting efficiency is worldwide partially to fight climate change. LED bulbs are currently significantly more efficient than incandescent and fluorescent light bulbs, and they lasts much longer. While LED bulbs are already economical when factoring in life time cost, they are highly cost sensitive because of the extremely low cost of the incandescent bulbs that they replace.

Current power supply designs use inductive transformers which dominate the cost of the LED light bulb systems in terms of power loss, footprint, and economics. Additionally, various designs implement a single capacitor in the rectifier circuit which sustains large positive and negative voltages requiring a large expensive capacitor capable of handling bipolar voltages, high voltages, and thus requiring large capacitance. Also, the prior designs operate at slower speeds and therefor are susceptible to flicker or require a large output capacitor and have power factor correction (PFC) problems.

One of the most costly portions of an LED bulb is the LED power supply apparatus. Therefore, there is a need for more efficient LED power supply structures.

### SUMMARY OF THE INVENTION

An inductor-less LED power pump includes a pair of circuit paths, a first path for driving a voltage charge to a charge capacitor during a first phase of a cycle from an alternating current power source and a second path for driving a voltage charge to the charge capacitor during a second phase of the cycle.

An inductor-less LED power supply includes an inductor-less power pump and current driver circuit to power one or more LEDs. An example power source may be conventional alternating current, such as by example, 120 Vrms (Volts RMS) at 60 Hz or 230 Vrms at 50 Hz,

These and other advantages and features of the invention will be apparent from the following description of the preferred embodiments, considered along with the accompanying drawings.

### BRIEF DESCRIPTION OF THE DRAWINGS

FIG. 1 is a block diagram of an inductor-less LED power supply architecture according to the present invention.

FIG. 2 is an example circuit diagram of the LED power supply architecture shown in FIG. 1.

FIG. 3 intentionally omitted.

FIG. 4 is an example charge pump circuit, according to the present invention.

FIG. 5 is an example current driver circuit according to the present invention.

FIGS. 6-A-6-Q illustrate transient signal flow of the example charge pump according to the present invention.

FIGS. 6-A-6-E illustrate transient signal flow of the example charge pump according to the present invention with clock-wise current flow orientation as the phase of the voltage source increases from 0-90 degrees and dv/dt is positive across C1 and drives a voltage across C3 to 70 V.

FIGS. 6-F-6-M illustrate transient signal flow of the example charge pump according to the present invention with counter-clod-wise current flow orientation as the phase of the voltage source increases from 90-180-270 degrees and dv/dt is positive across C1 and drives a voltage across C3 to 70 V.

FIGS. 6-N-6-Q illustrate transient signal flow of the example charge pump according to the present invention with clock-wise current flow orientation as the phase of the voltage source increases from 270-360 degrees and dv/dt is positive across C1 and drives a voltage across C3 to 70 V.

FIGS. 7-A-7-R illustrate steady-state signal flow of the example charge pump in a LED power supply architecture according to the present invention.

FIGS. 7-A-7-F illustrate steady-state signal flow of the example charge pump according to the present invention with clock-wise current flow orientation as the phase of the voltage source increases from 270-360-90 degrees and dv/dt is positive across C1 and drives a voltage across C3 to 70 V. (FIGS. 7-O-7-R show flow from 270-360 degrees; FIGS. 7-A-7-F show flow from approximately 345-90 degrees)

FIGS. 7-G -7-N illustrate steady-state signal flow of the example charge pump according to the present invention with counter-clock-wise current flow orientation as the phase of the voltage source increases from 90-180-270 degrees and dv/dt is positive across C1 and drives a voltage across C3 to 70 V.

FIG. 8 shows an example A/C voltage source waveform and capacitor (C1, C2) waveforms for the charge pump.

FIG. 9 shows an example A/C voltage source waveform, charge capacitor C3 voltage waveform, and current waveforms across C1, C2.

FIG. 10 shows an example LED current waveform.

FIG. 11 shows example capacitor voltage and diode current waveforms.

FIGS. 12-A-12-O illustrate transient signal flow of the example charge pump according to the present invention with an alternative example voltage source of 230 V RMS (325 V peak) at a cycle of 120 Hz.

FIGS. 12-A-12-E illustrate transient signal flow of the example charge pump according to the present invention with clock-wise current flow orientation as the phase of the voltage source increases from 0-90 degrees and dv/dt is positive across C1 and drives a voltage across C3 to 90 V.

FIGS. 12-F-12-L illustrate transient signal flow of the example charge pump according to the present invention with counter-clock-wise current flow orientation as the phase of the voltage source increases from 90-180-270 degrees and dv/dt is positive across C1 and drives a voltage across C3 to 90 V.

FIGS. 12-M-12-O illustrate transient signal flow of the example charge pump according to the present invention with clock-wise current flow orientation as the phase of the voltage source increases from 270-360 degrees and dv/dt is positive across C1 and drives a voltage across C3 to 90 V.

### DETAILED DESCRIPTION OF PREFERRED EMBODIMENTS

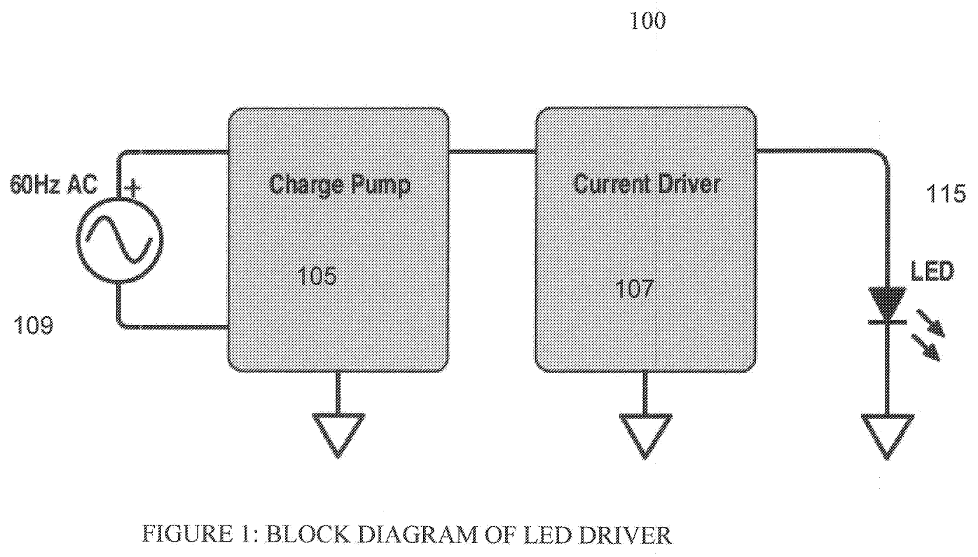

FIG. 1 is a high level block diagram of LED (light-emitting diode) power supply architecture 100 providing a power-efficient design for implementation with LED light bulbs. Power supply architecture 100 includes charge pump 105 and current driver 107. Charge pump 105 uses the input signal from a voltage source, such as 120 V RMS (170 V peak) sinusoidal source with a clock cycle of 60 Hz, to pump charge into a supply capacitor and hold voltage across the supply capacitor at a substantially constant voltage, e.g. 70 Vdc,. This supply capacitor provides charge to current driver 107. Current driver 107 powers LED 115.

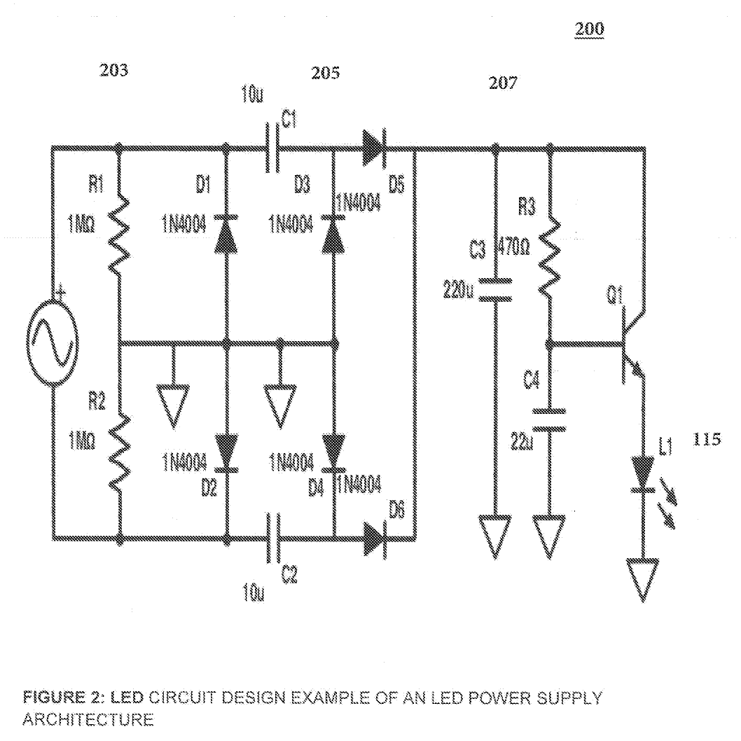

FIG. 2 is an example detailed circuit diagram 200 of an LED power supply architecture according to the present invention that includes rectifier circuit 203, charge pump circuit 205, and current driver circuit 207 which operate as described above. Two push-pull capacitors C1 (10 micro-farads), C2 (10 micro-farads) may be aluminum electrolytic capacitors and are implemented between the rectifier circuit outputs and charge pump inputs and function together as a polarized electrolytic capacitor. D1 (1N4004) and D2 (1N4004) diodes conduct current when the supply capacitors reach 0 V. The higher voltage line signal is applied to C1 or C2 as a half sine-wave. C1 and C2 along with Diodes D3-6 (1N4004) form a charge pump circuit to deliver charges to C3 (220 micro-farads). Q1 along with R3 (470 ohms) and C4 (22 micro-farads) is a low drop out regulator to smooth out the output voltage and reduces flicker, e.g. 120 Hz flicker. The Q1 circuit is not essential but if flicker is important, using this regulator circuit may reduce flicker and the size of C3 at the expense of some lost in power efficiency. The output LED 115 may be a series of LEDa, such as a string of two or more LEDs (e.g. 16 LEDs NSPW500BS, each with a voltage drop of approximately 4.2 V).

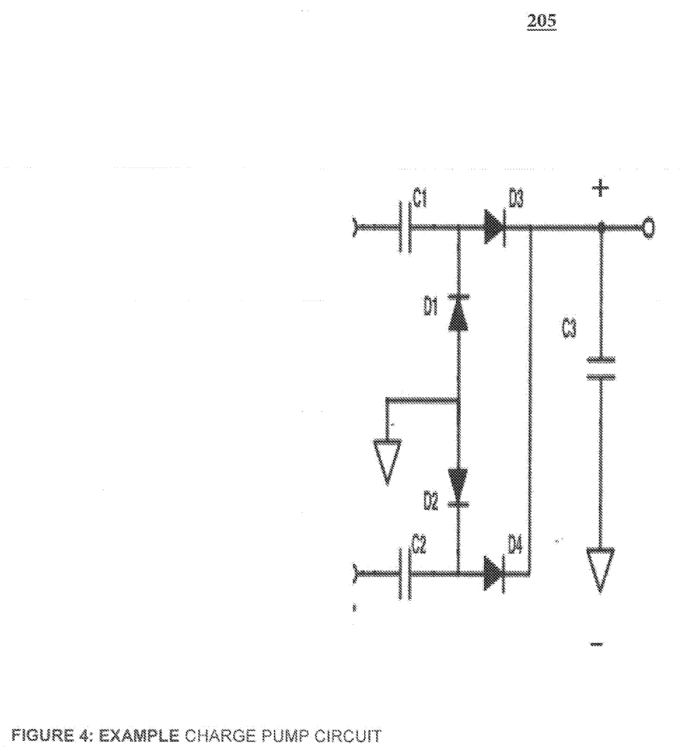

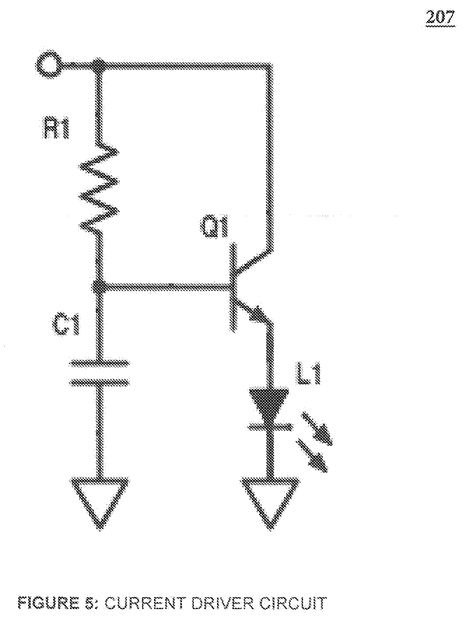

FIG. 4 is an example charge pump circuit 205, according to the present invention.

FIG. 5 is an example current driver circuit 207 according to the present invention. The final stage of the LED driver is a low pass filter connected to a transistor in common collector configuration. The purpose of this circuit is to drive the LEDs with reduced ripple. The specific design of this circuit is not an essential part of the LED driver. This circuit only needs to behave as a current supply for the LEDs.

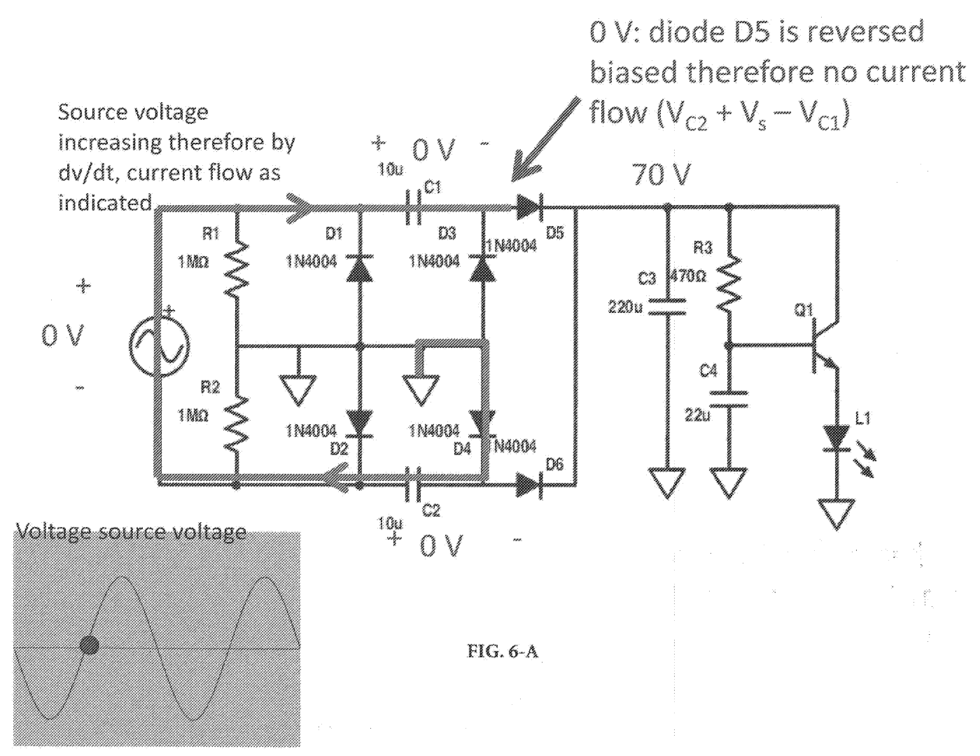

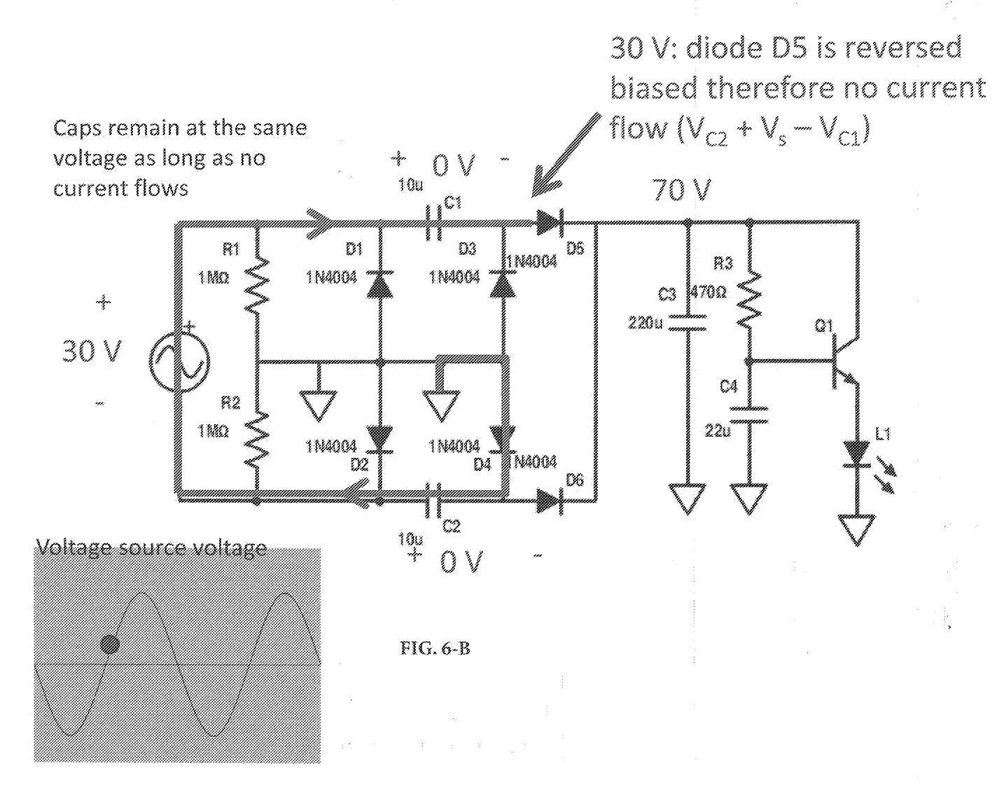

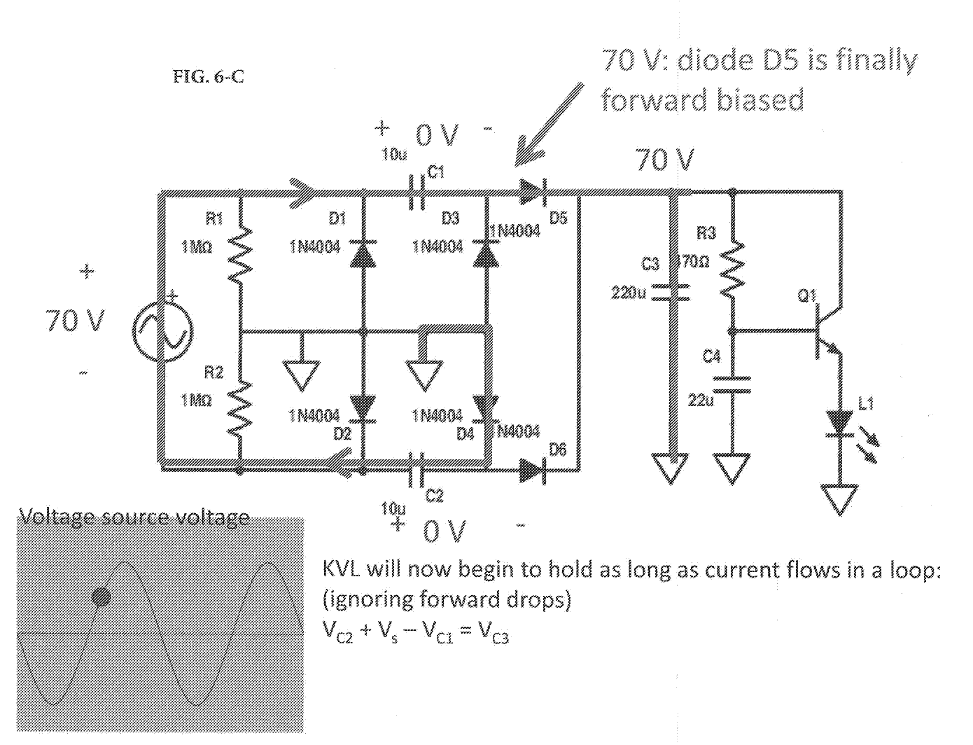

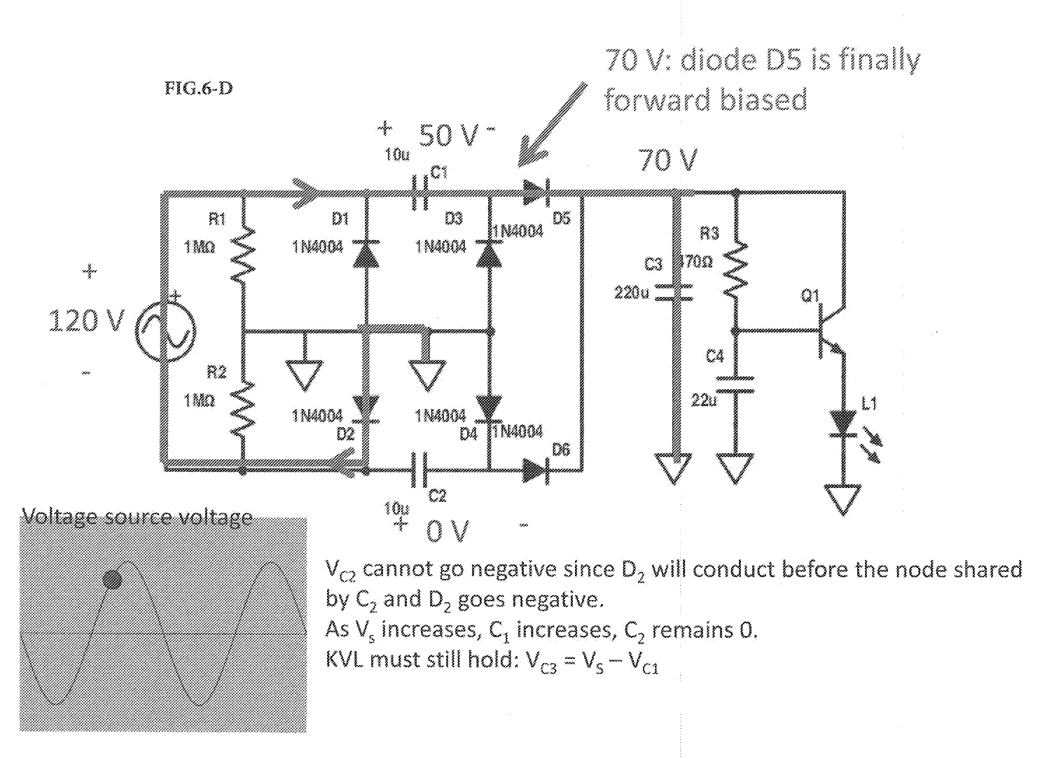

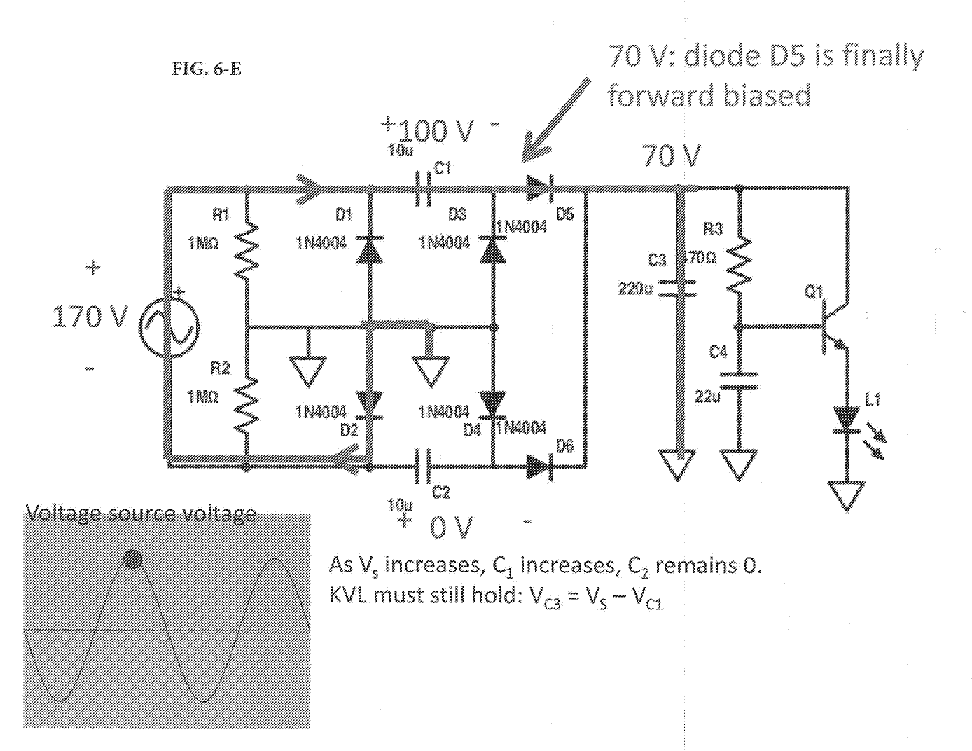

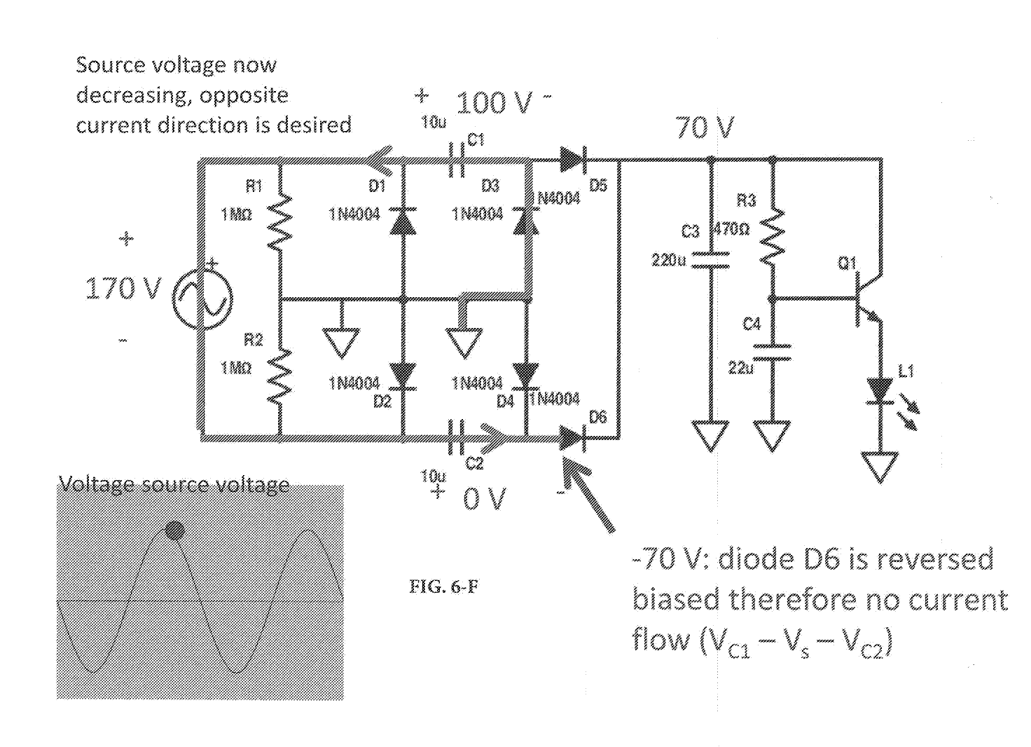

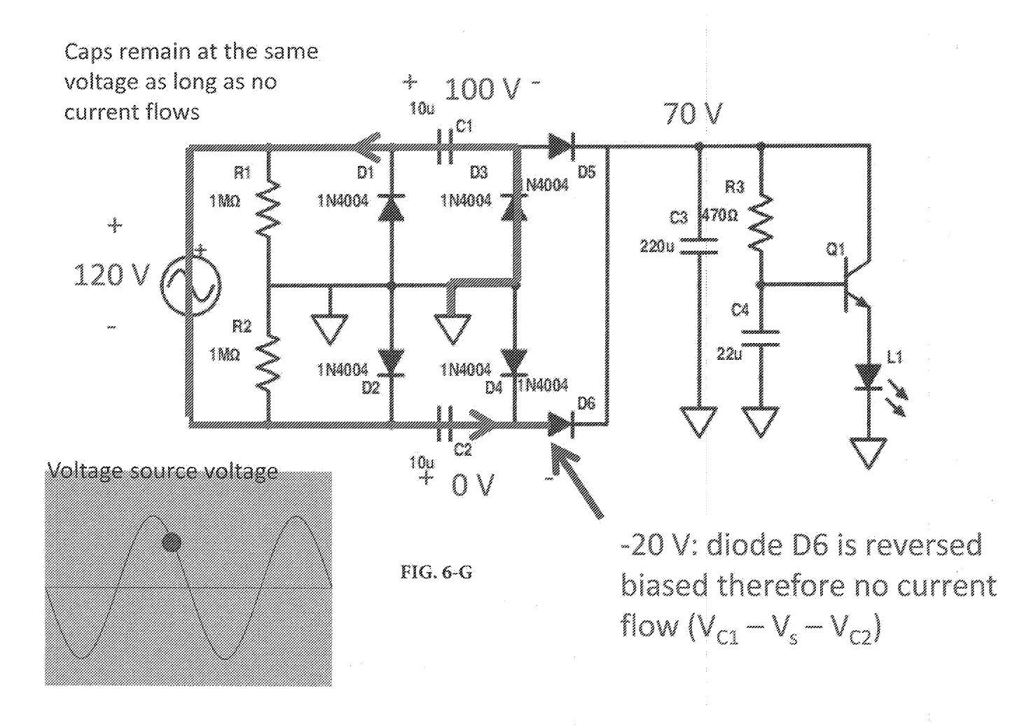

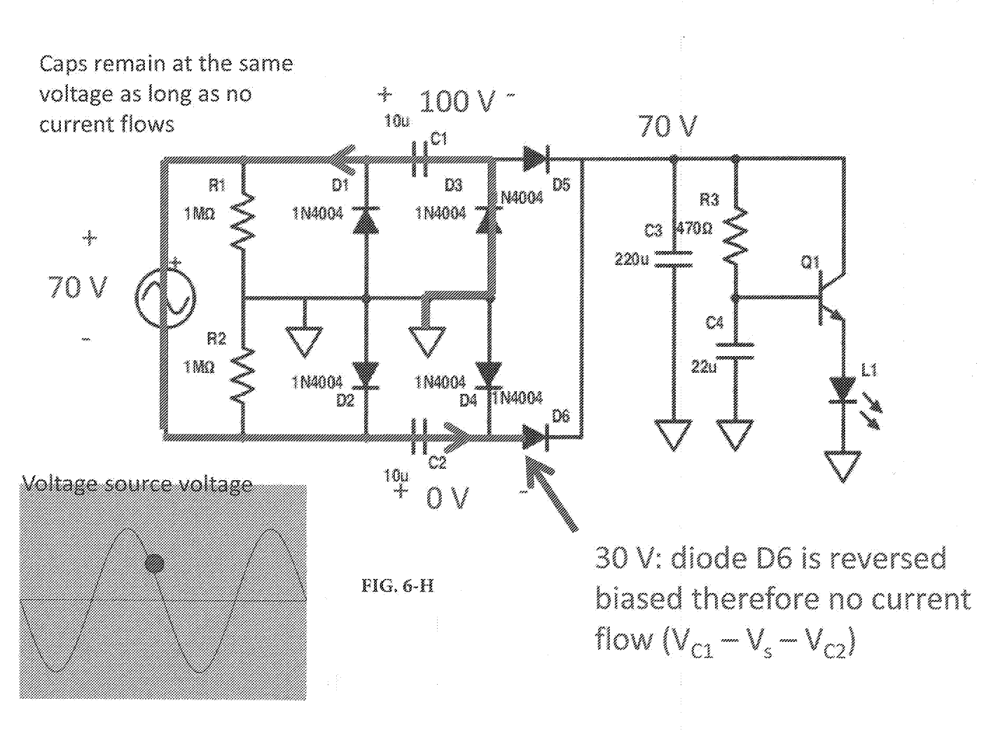

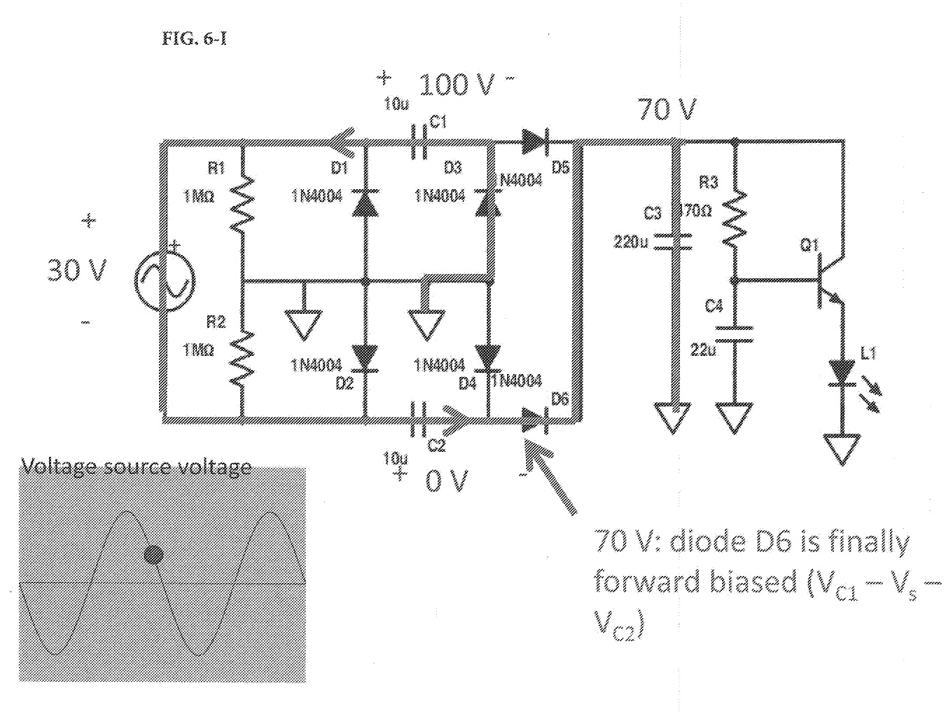

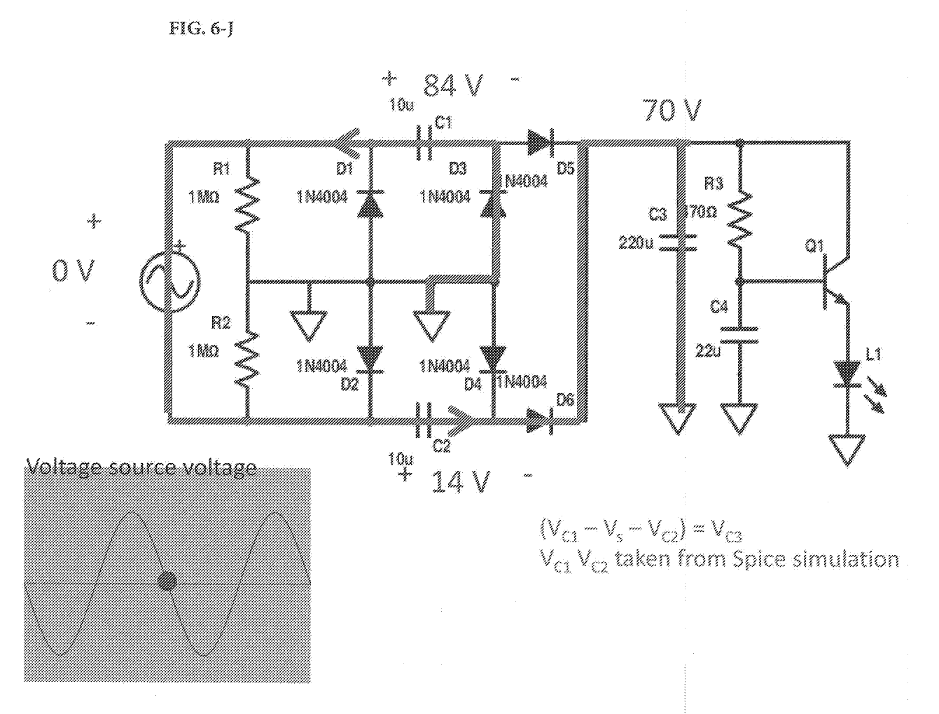

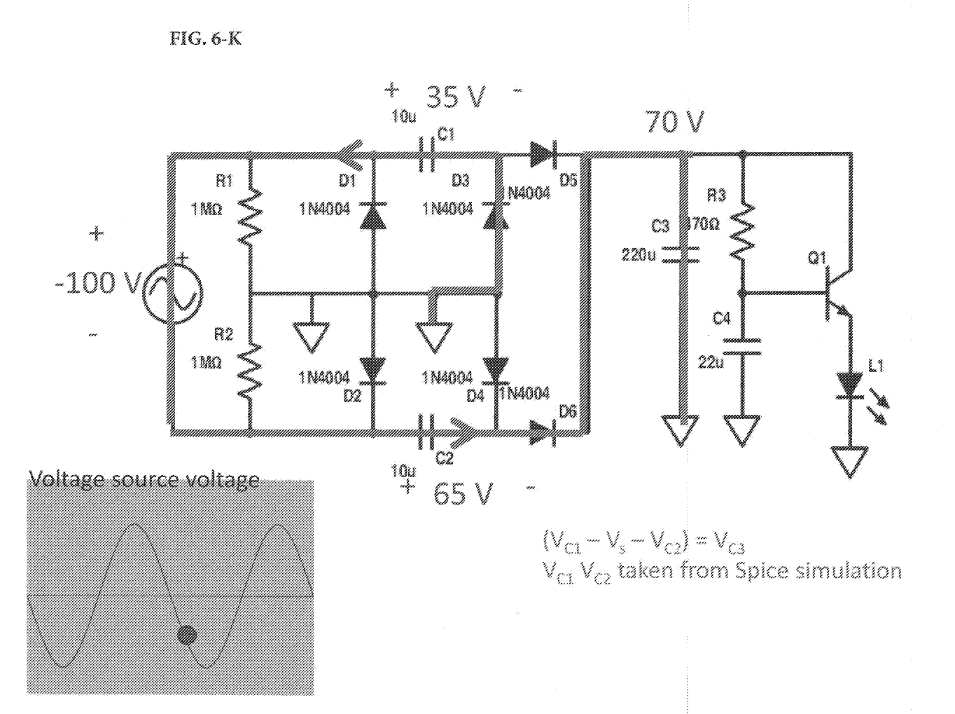

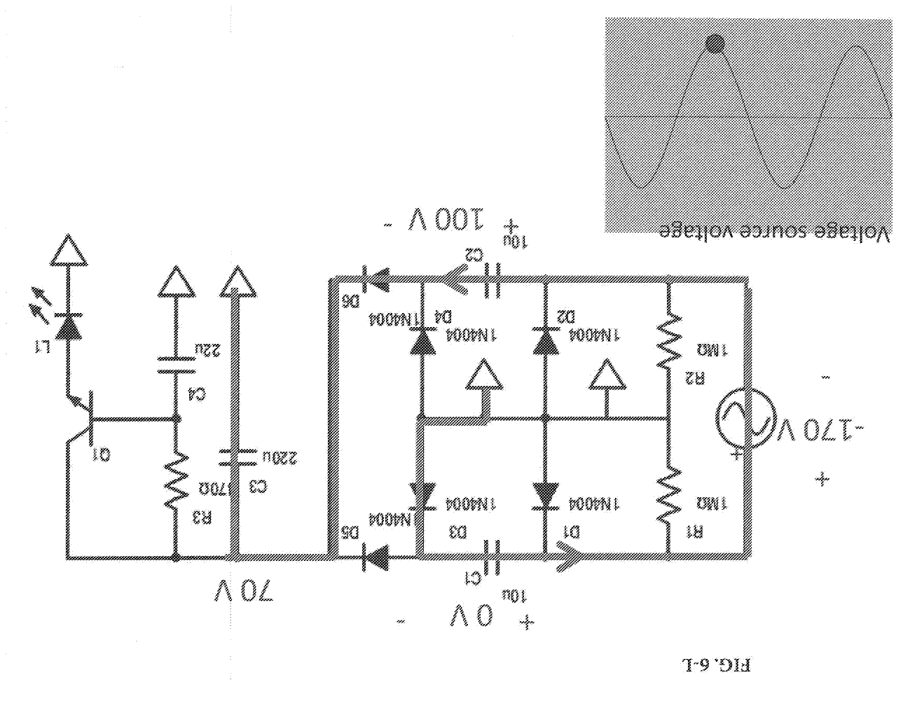

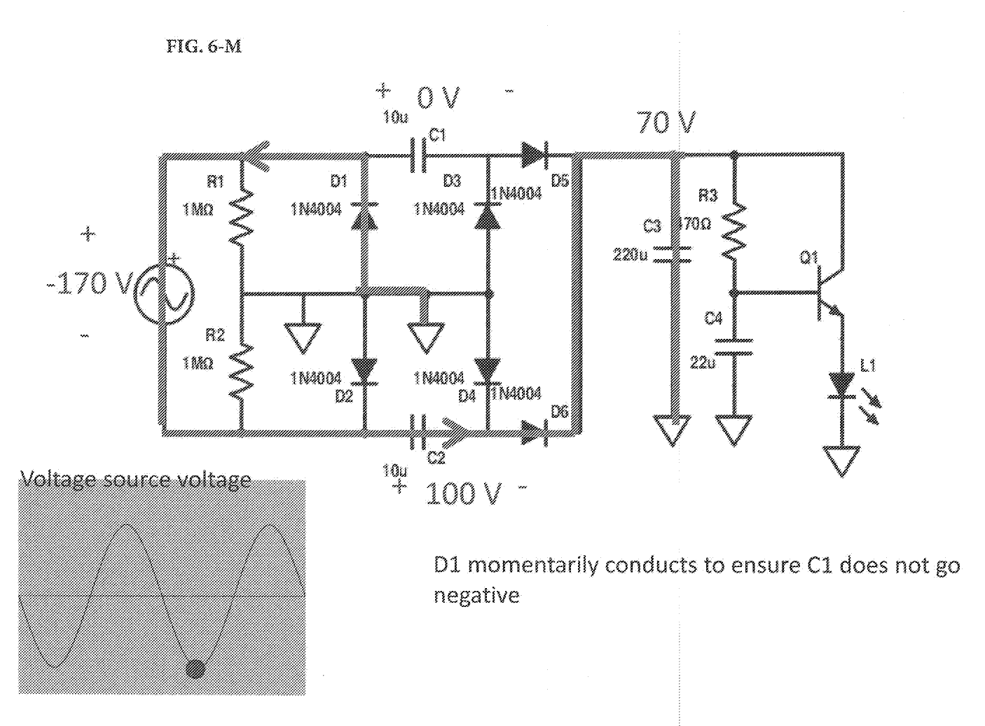

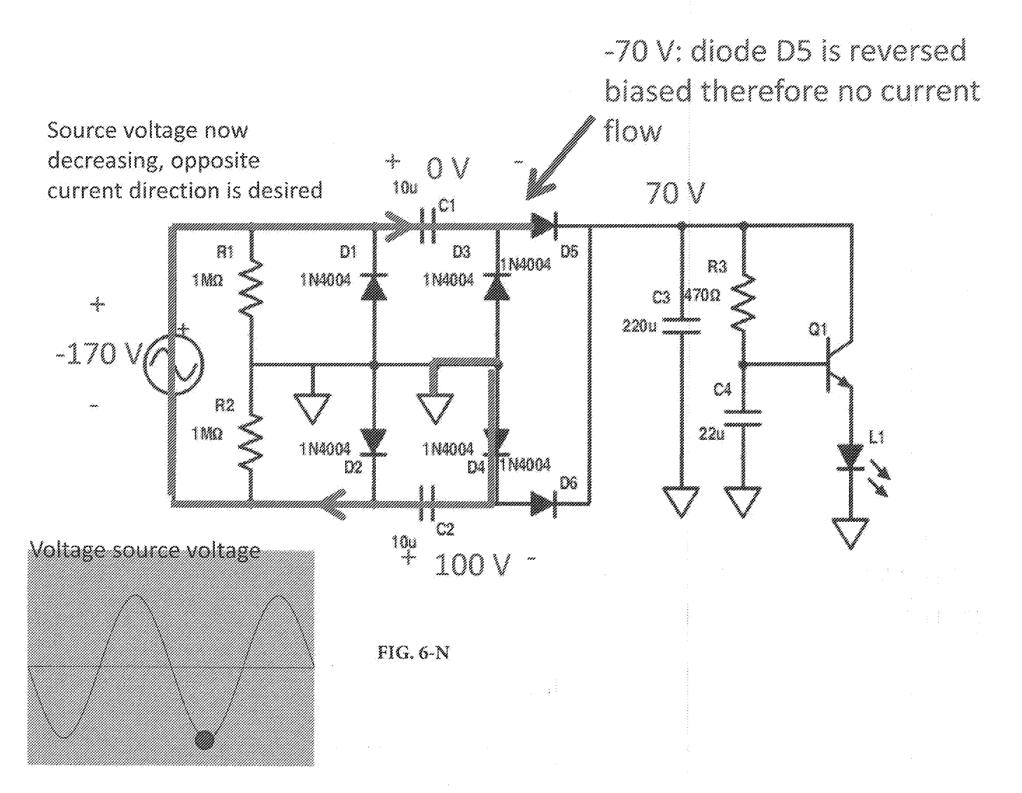

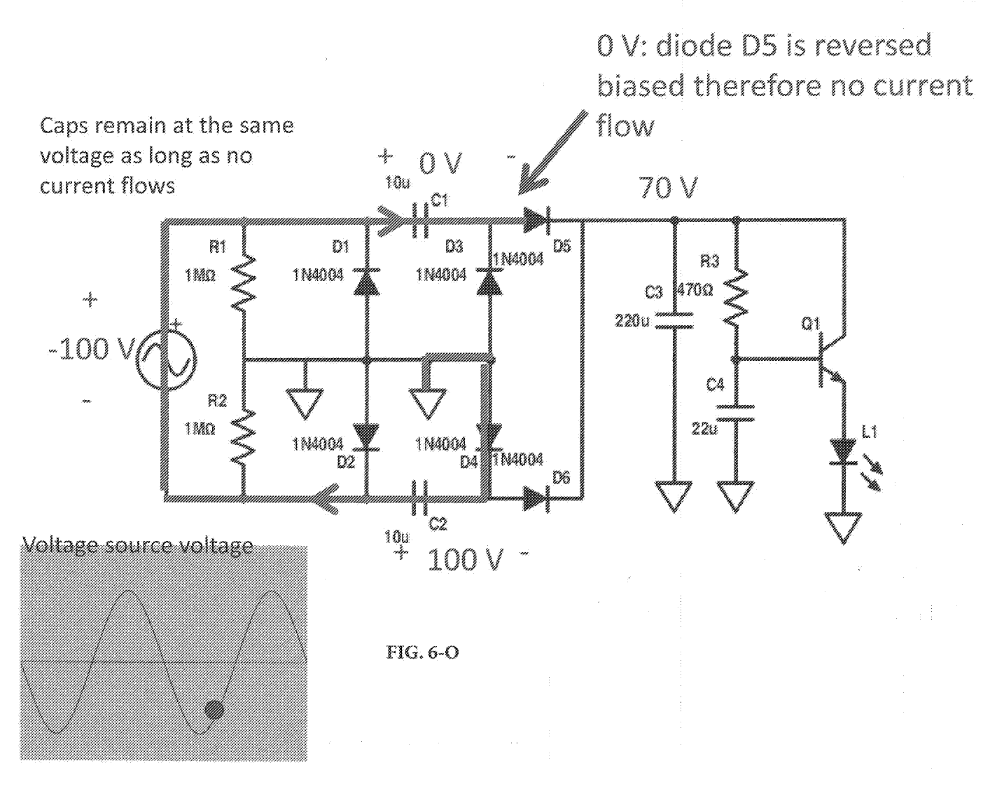

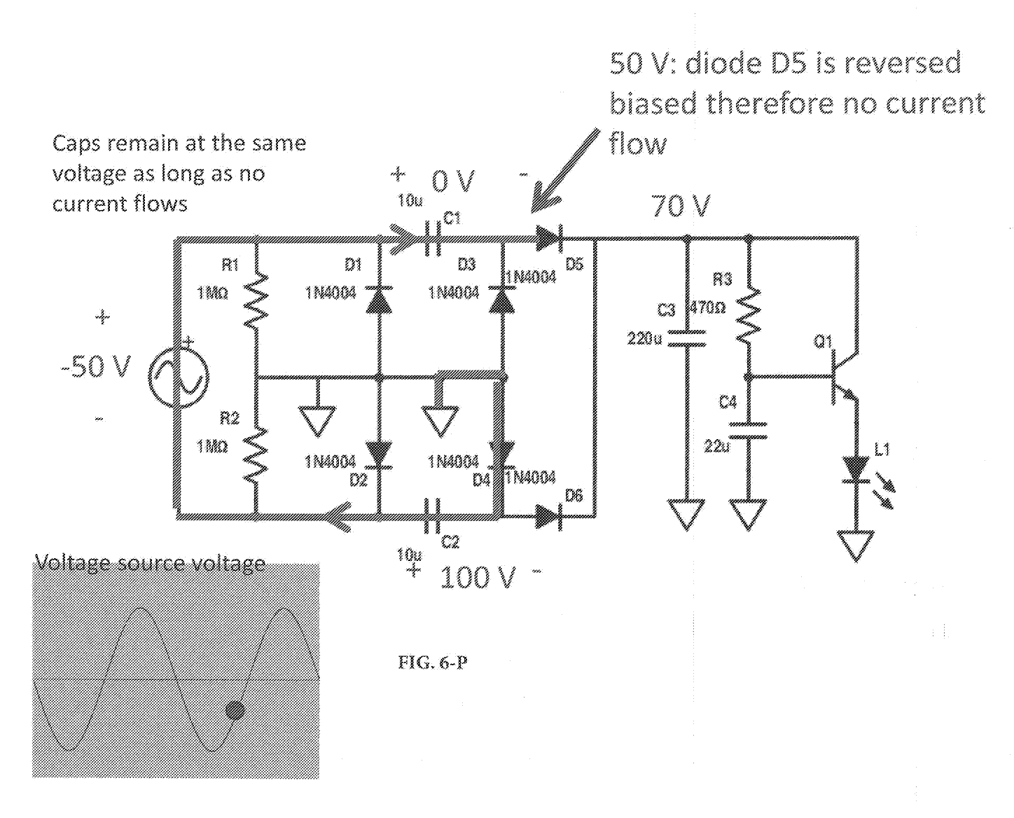

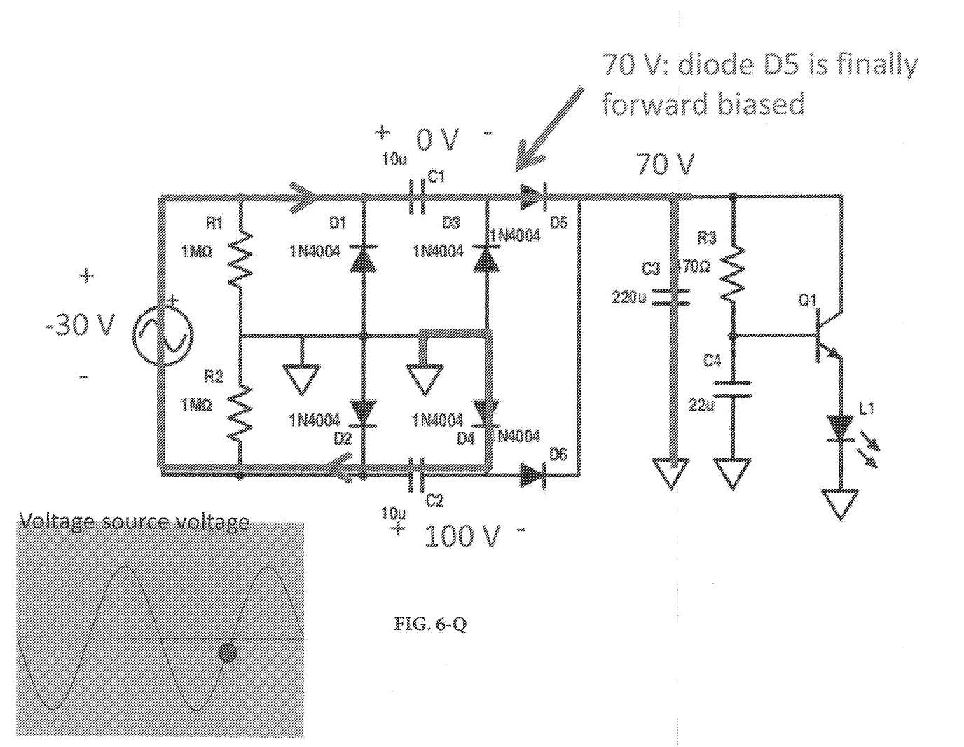

FIGS. 6-A-6-Q illustrate transient signal flow of the example charge pump according to the present invention. FIGS. 6-A-6-E illustrate transient signal flow of the example charge pump according to the present invention with clock-wise current flow orientation as the phase of the voltage source increases from 0-90 degrees and dv/dt is positive across C1 and drives a voltage across C3 to 70 V. FIGS. 6-F-6-M illustrate transient signal flow of the example charge pump according to the present invention with counter-clock-wise current flow orientation as the phase of the voltage source increases from 90-180-270 degrees and dv/dt is positive across C1 and drives a voltage across C3 to 70 V. FIGS. 6-N-6-Q illustrate transient signal flow of the example charge pump according to the present invention with clock-wise current flow orientation as the phase of the voltage source increases from 270-360 degrees and dv/dt is positive across C1 and drives a voltage across C3 to 70 V.

Clock-wise transient flow orientation

FIG. 6-A illustrates a transient signal flow of the example charge pump according to the present invention wherein the voltage source is at or about zero volts and zero phase with an increasing voltage. Each of capacitors C1 and C2 have zero voltage across them and storage capacitor C3 has 70 V stored across it from an earlier cycle. Thus, although there is a clockwise orientation of current due to the positive dv/dt across each of the voltage source and C1 and C2, there is zero current flow since all voltages in the power pump circuit are zero and both diodes D5, D6 are reverse biased against flow from C3.

FIG. 6-B illustrates a transient signal flow of the example charge pump according to the present invention wherein the voltage source is at or about 30 V and thirty degree phase with an increasing voltage. Each of capacitors C1 and C2 has zero voltage across them storage capacitor C3 has a 70 V (volts) charge across it from an earlier cycle. Thus, although there is a clockwise orientation of current due to the positive dv/dt across each of the 30 V voltage source and C1 and C2, there is zero current flow and both diodes D5, D6 are reverse biased against flow from C3.

FIG. 6-C illustrates a transient signal flow of the example charge pump according to the present invention wherein the voltage source is at or about 70 V and thirty degree phase with an increasing voltage. Each of capacitors C1 and C2 have zero voltage across them as storage capacitor C3 has 70 V stored across it. There is a clockwise orientation of current due to the positive dv/dt across C1 and C3 driven by the 70 V voltage source since diode D5 is forward-biased and current flows across C3.

FIG. 6-D illustrates a transient signal flow of the example charge pump according to the present invention wherein the voltage source is at or about 120 V volts and sixty degree phase with an increasing voltage. There is a clockwise current due to the voltage source, and D5 is forward biased to allow current flow across C1 and C3. While the voltage source is at 120 V, C1 has a 50 V charge and storage capacitor C3 has a 70 V charge across it.

FIG. 6-E illustrates a transient signal flow of the example charge pump according to the present invention wherein the voltage source is at or about 170 V volts and ninety degree phase with an increasing voltage. There is a clockwise current due to the voltage source, and D5 is forward biased to allow current flow across C1 and C3. While the voltage source is at 170 V, C1 has a 100 V charge and storage capacitor C3 has a 70 V charge across it.

Counter-clock-wise transient flow orientation

FIG. 6-F illustrates a transient signal flow of the example charge pump according to the present invention wherein the voltage source is at or about 170 V and ninety-plus phase with a decreasing voltage. C1 has a 100 V charge, C2 has a 0 V charge and storage capacitor C3 has a 70 V charge. Thus, although there is a counter-clockwise orientation of current due to the negative dv/dt across each of the voltage source and C1 and C2, there is zero current flow as D6 has a negative 70 V across it and remains reverse biased.

FIG. 6-G illustrates a transient signal flow of the example charge pump according to the present invention wherein the voltage source is at or about 120 V and one hundred twenty degree phase with a decreasing voltage. C1 has a 100 V charge, C2 has a 0 V charge and storage capacitor C3 has a 70 V charge. Thus, although there is a counter-clockwise orientation of current due to the negative dv/dt across each of the voltage source and C1 and C2, there is zero current flow as D6 has a negative 20 V across it and remains reverse biased.

FIG. 6-H illustrates a transient signal flow of the example charge pump according to the present invention wherein the voltage source is at or about 70 V and one hundred thirty-five degree phase with a decreasing voltage. C1 has a 100 V charge, C2 has a 0 V charge and storage capacitor C3 has a 70 V charge. Thus, although there is a counter-clockwise orientation of current due to the negative dv/dt across each of the voltage source and C1 and C2, there is zero current flow as D6 remains reverse biased.

FIG. 6-I illustrates a transient signal flow of the example charge pump according to the present invention wherein the voltage source is at or about 30 V and one hundred fifty degree phase with a decreasing voltage. C1 has a 100 V charge, C2 has a 0 V charge and storage capacitor C3 has a 70 V charge. There is a counter-clockwise orientation of current due to the negative dv/dt across each of the voltage source and C1 and C2, and D6 becomes forward biased.

FIG. 6-J illustrates a transient signal flow of the example charge pump according to the present invention wherein the voltage source is at or about 0 V and one hundred eighty degree phase with a decreasing voltage. C1 has a 84 V charge, C2 has a 14 V charge and storage capacitor C3 has a 70 V charge. There is a counter-clockwise orientation of current due to the negative dv/dt across each of the voltage source and C1 and C2, and D6 is forward biased.

FIG. 6-K illustrates a transient signal flow of the example charge pump according to the present invention wherein the voltage source is at or about −100 V and two hundred fifty degree phase with a decreasing voltage. C1 has a 35 V charge, C2 has a 65 V charge and storage capacitor C3 has a 70 V charge. There is a counter-clockwise orientation of current due to the negative dv/dt across each of the voltage source and C1 and C2, and D6 is forward biased.

FIG. 6-L illustrates a transient signal flow of the example charge pump according to the present invention wherein the voltage source is at or about −170 V and two hundred seventy degree phase with a decreasing voltage. C1 has a 0 V charge, C2 has a 100 V charge and storage capacitor C3 has a 70 V charge. There is a counter-clockwise orientation of current due to the negative dv/dt across each of the voltage source and C1 and C2, and D6 is forward biased.

FIG. 6-M illustrates a transient signal flow of the example charge pump according to the present invention wherein the voltage source is at or about −170 V and two hundred seventy degree phase with an increasing voltage. C1 has a 0 V charge, C2 has a 100 V charge and storage capacitor C3 has a 70 V charge. There is a clockwise orientation of current due to the positive dv/dt across each of the voltage source and C1 and C2, and D6 is forward biased. D1 momentarily conducts to ensure C1 does not go negative.

Clock-wise transient flow orientation

FIG. 6-N illustrates a transient signal flow of the example charge pump according to the present invention wherein the voltage source is at or about −170 V and two hundred seventy degree phase with an increasing voltage. C1 has a 0 V charge, C2 has a 100 V charge and storage capacitor C3 has a 70 V charge. There is a clockwise orientation of current due to the positive dv/dt across each of the voltage source and C1 and C2, and D5, D6 are reverse biased.

FIG. 6-O illustrates a transient signal flow of the example charge pump according to the present invention wherein the voltage source is at or about −100 V and three hundred degree phase with an increasing voltage. C1 has a 0 V charge, C2 has a 100 V charge and storage capacitor C3 has a 70 V charge. There is a clockwise orientation of current due to the positive dv/dt across each of the voltage source and C1 and C2, and D5, D6 are reverse biased.

FIG. 6-P illustrates a transient signal flow of the example charge pump according to the present invention wherein the voltage source is at or about −50 V and three hundred fifteen degree phase with an increasing voltage. C1 has a 0 V charge, C2 has a 100 V charge and storage capacitor C3 has a 70 V charge. There is a clockwise orientation of current due to the positive dv/dt across each of the voltage source and C1 and C2, and D5, D6 are reverse biased.

FIG. 6-Q illustrates a transient signal flow of the example charge pump according to the present invention wherein the voltage source is at or about −30 V and three hundred fifteen degree phase with an increasing voltage. C1 has a 0 V charge, C2 has a 100 V charge and storage capacitor C3 has a 70 V charge. There is a clockwise current due to the positive dv/dt across each of the voltage source and C1 and C2, and D5 is forward biased.

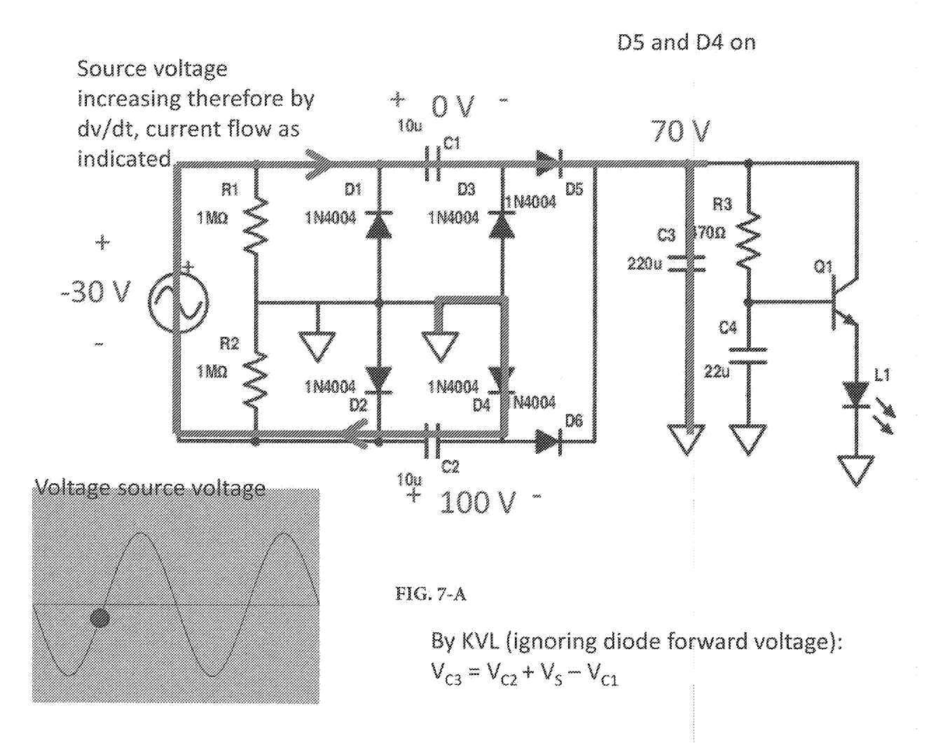

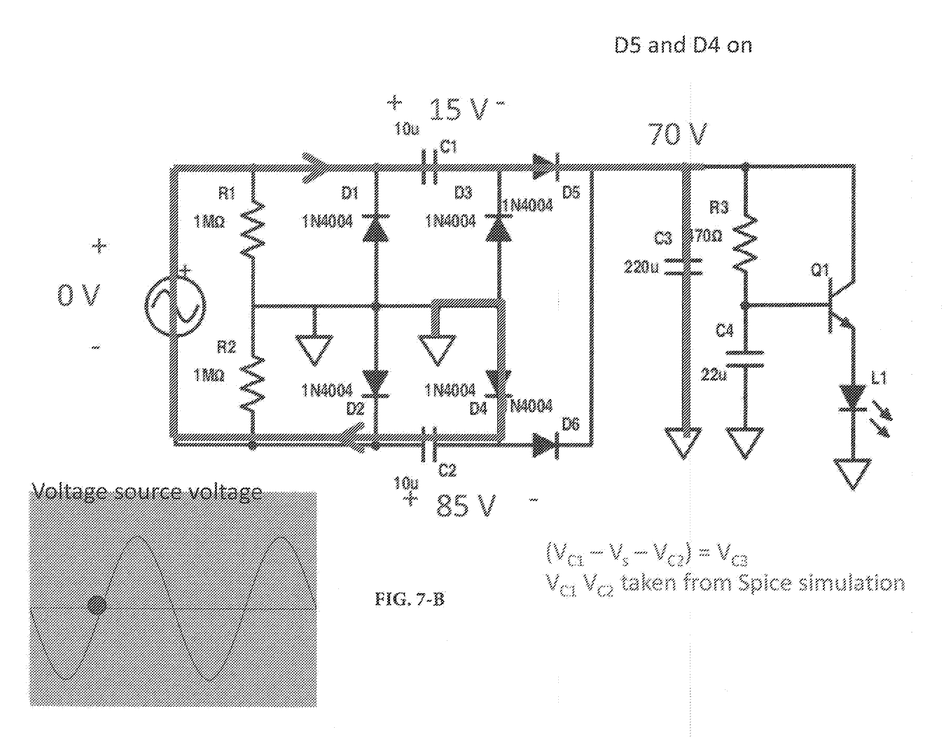

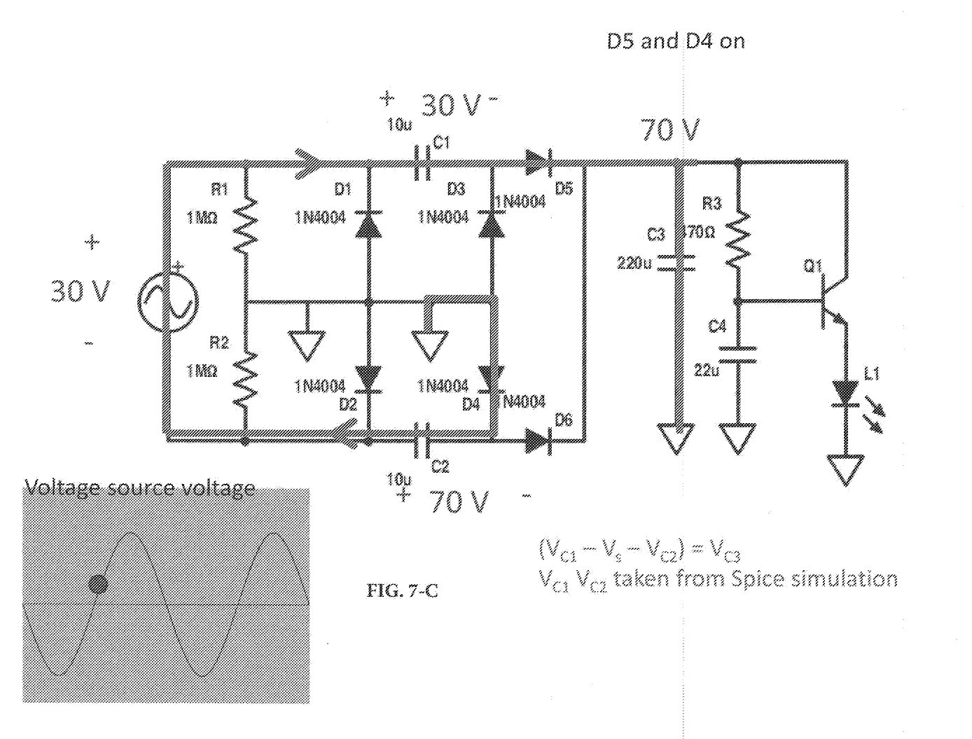

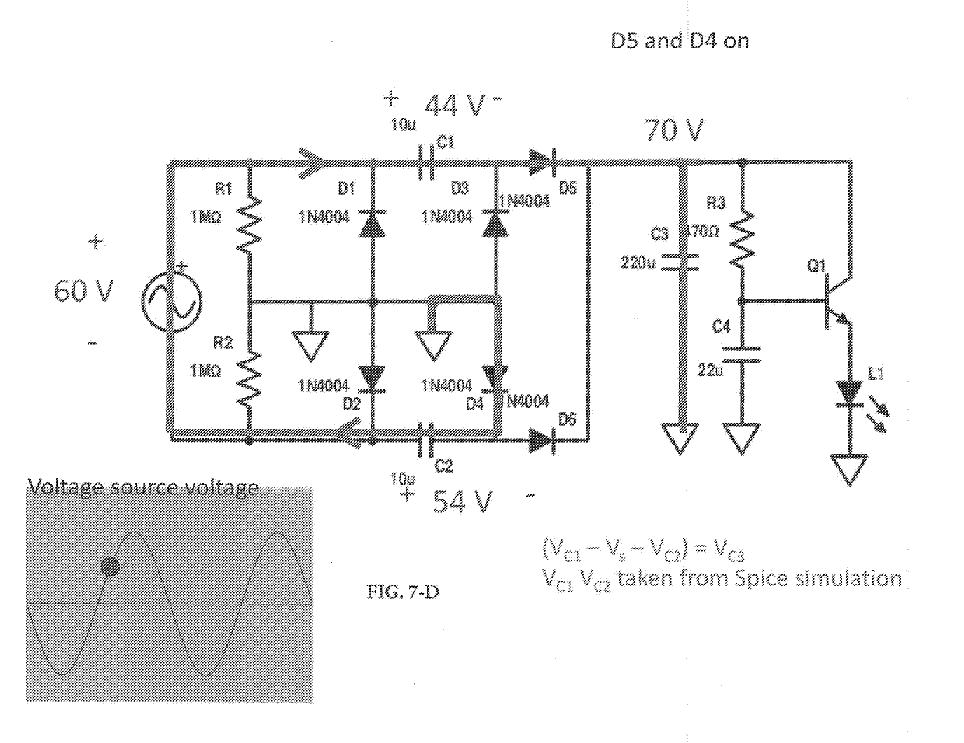

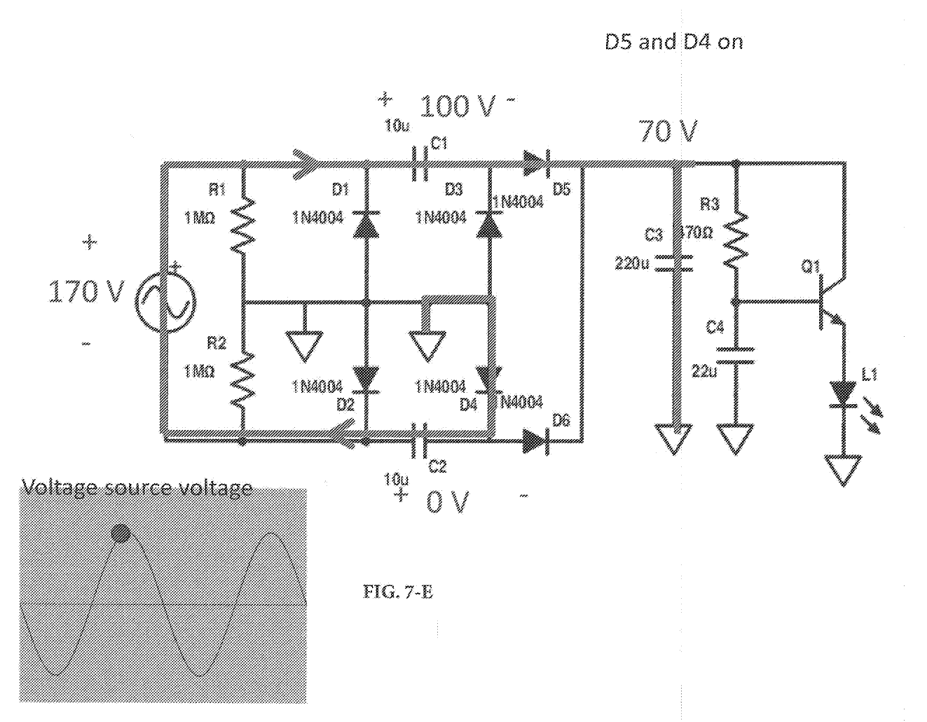

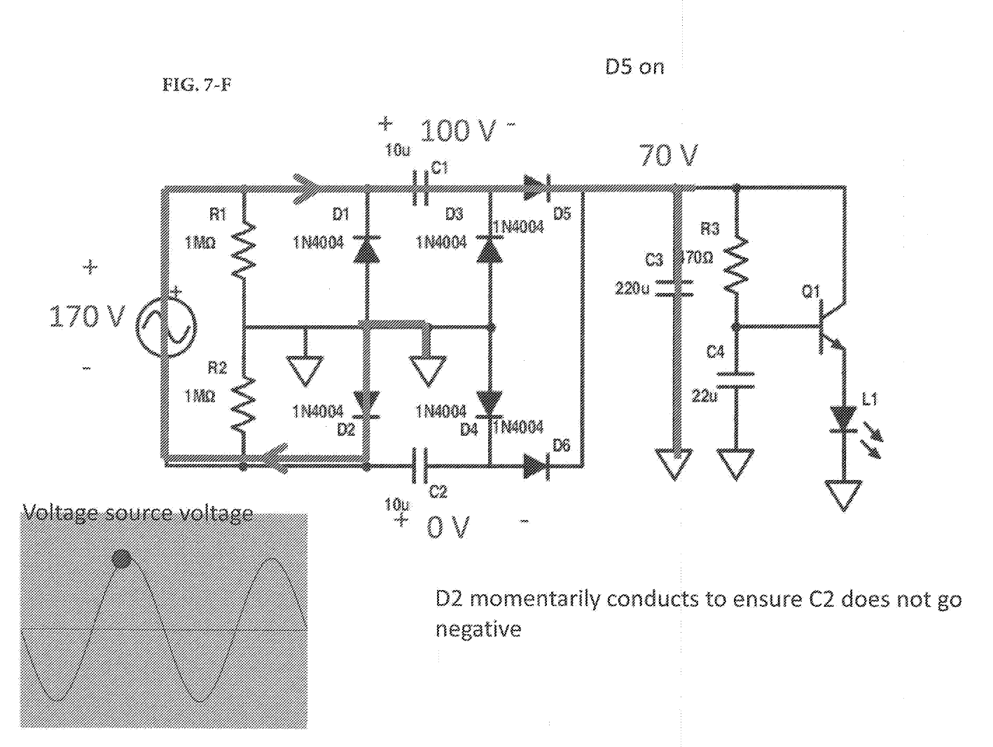

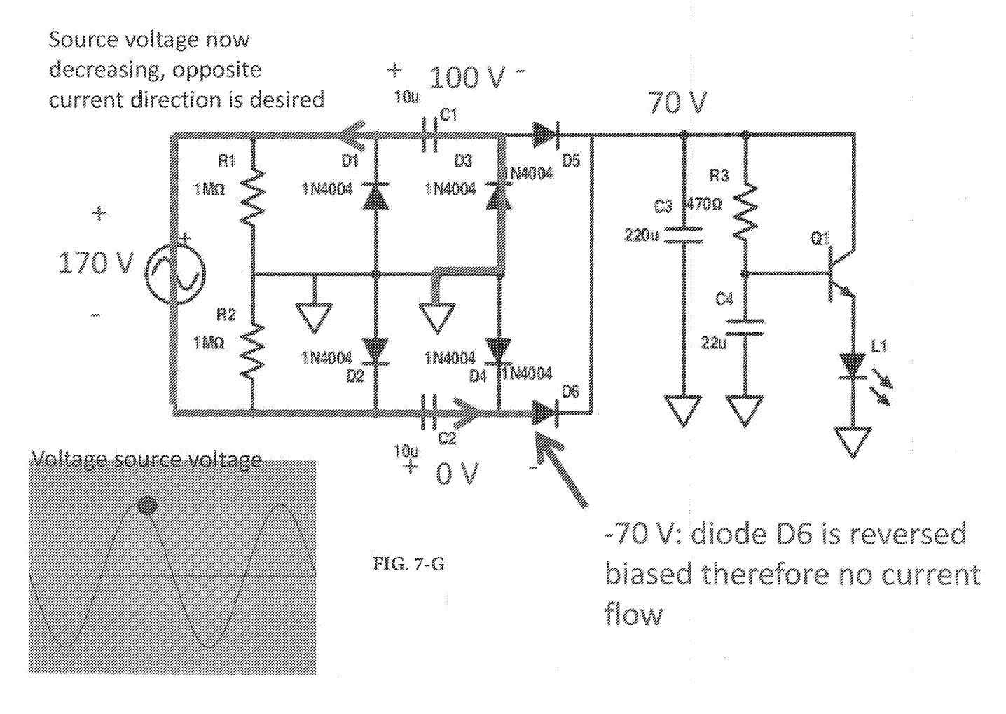

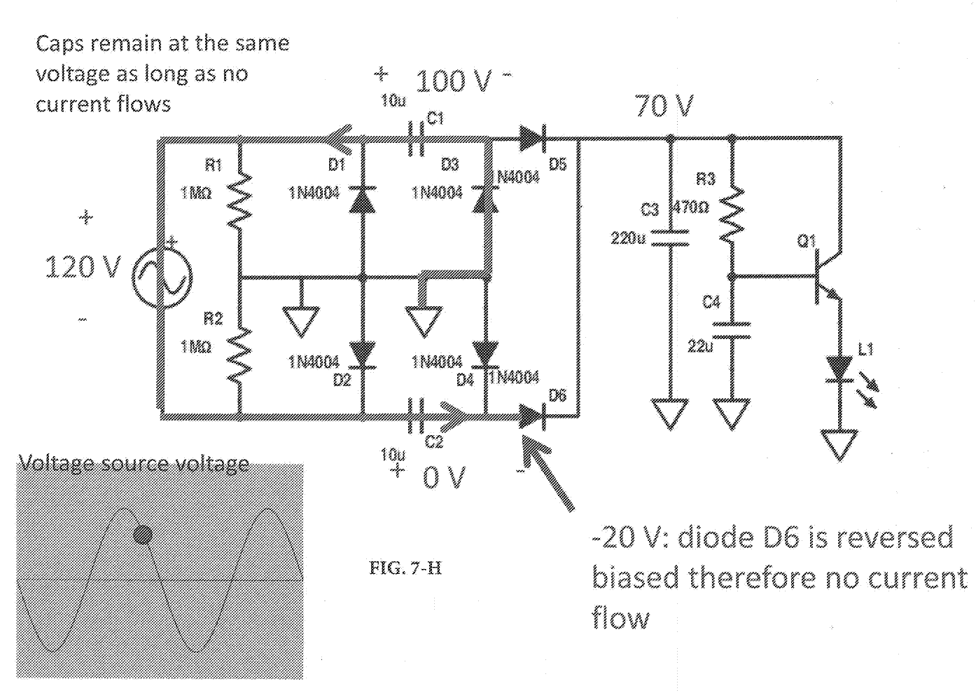

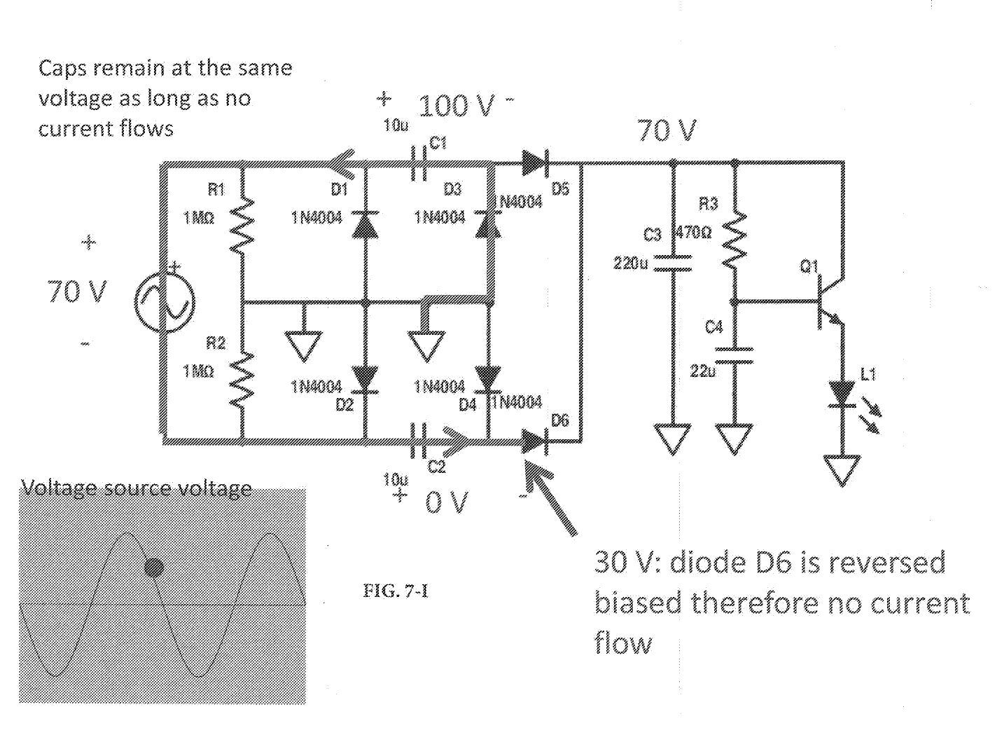

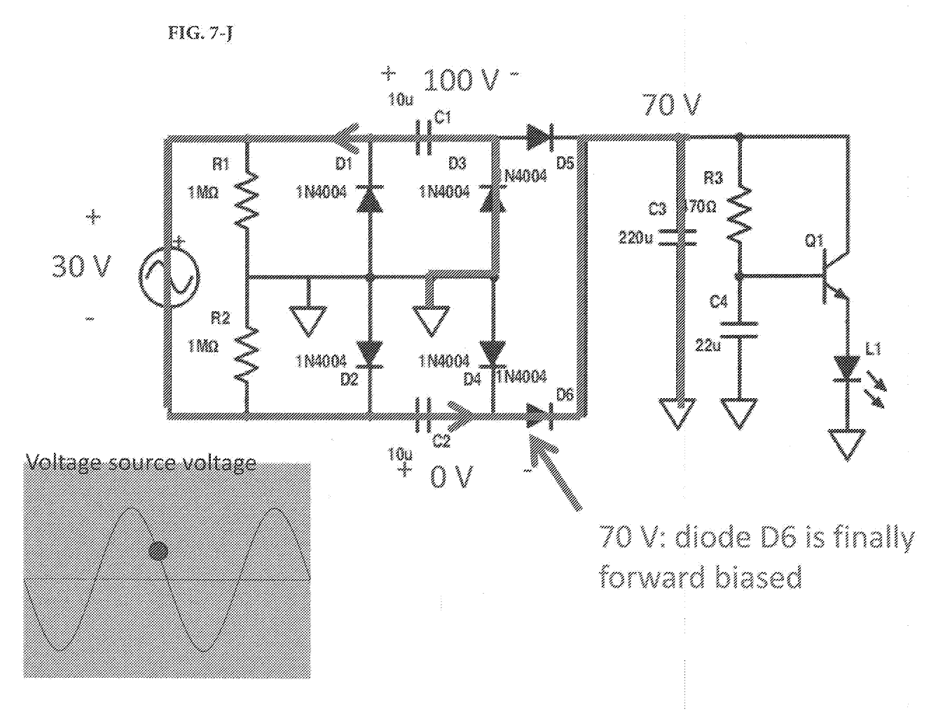

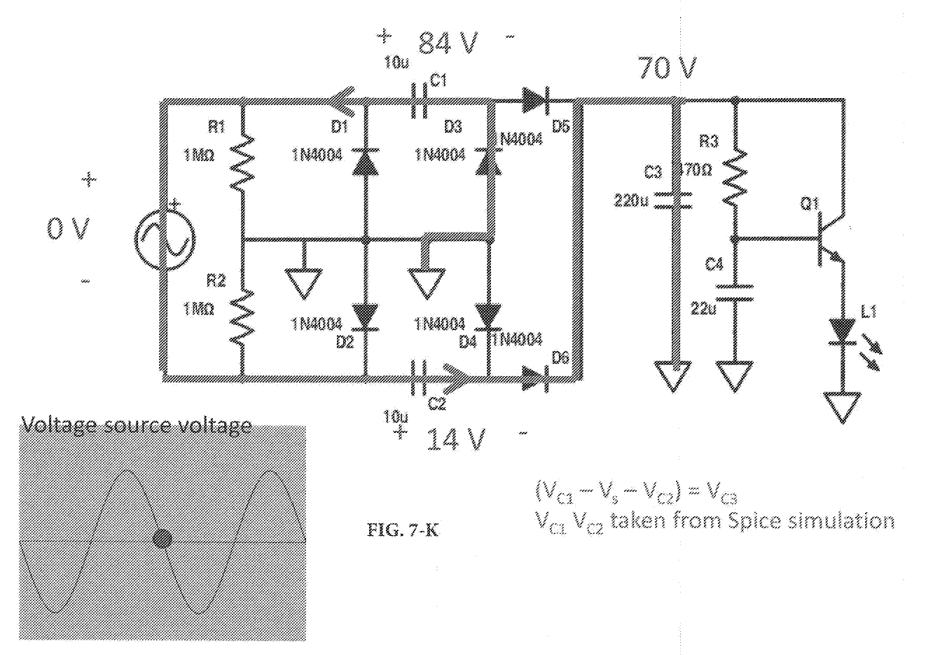

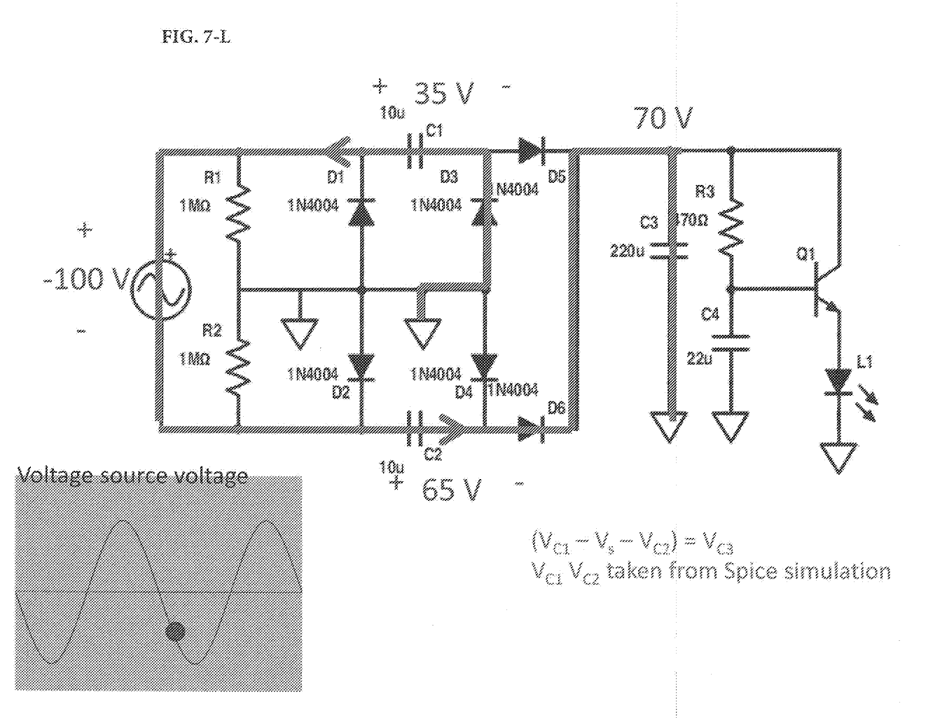

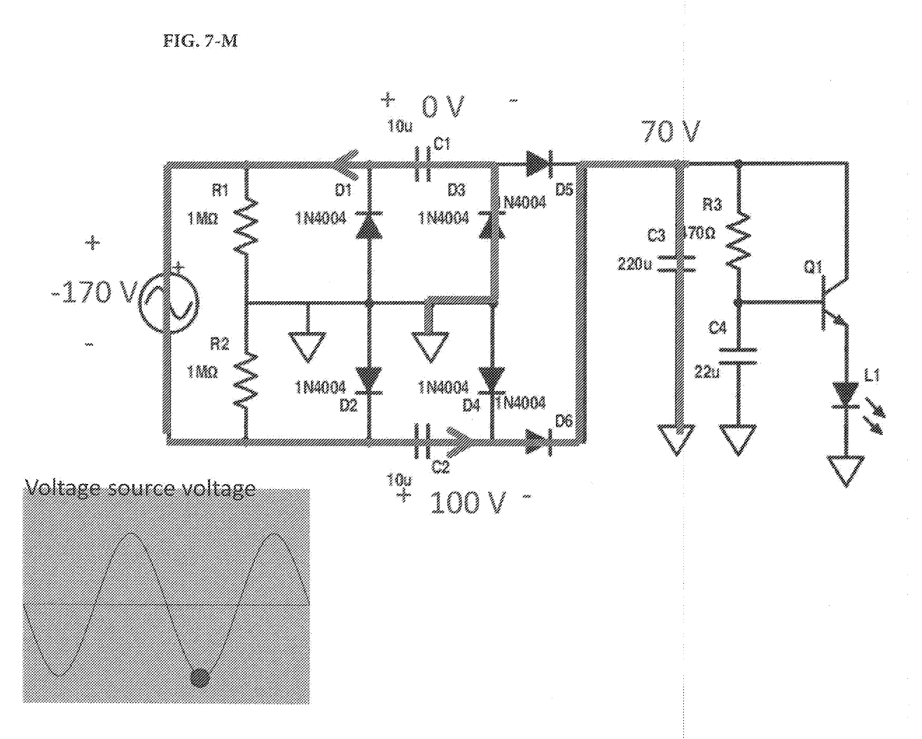

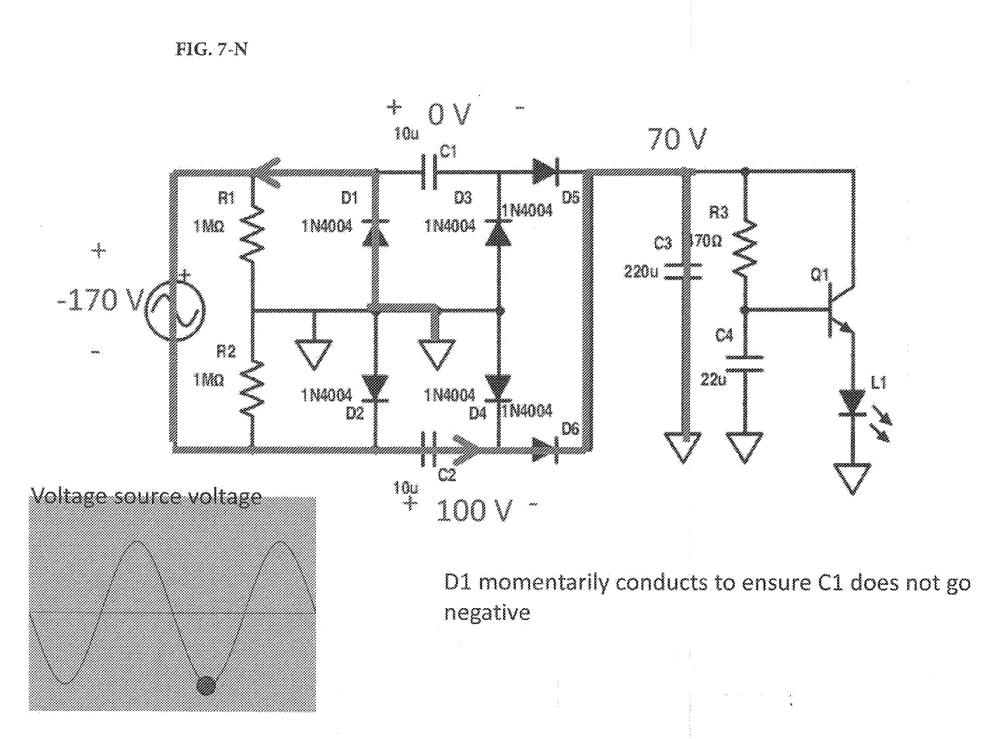

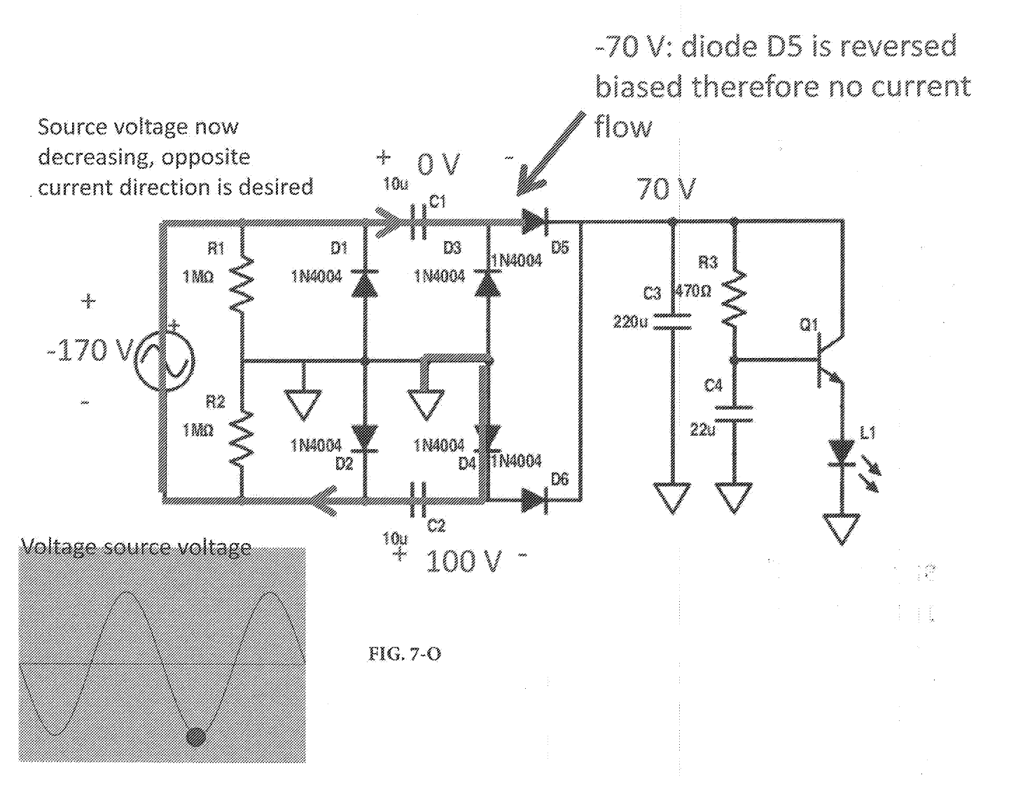

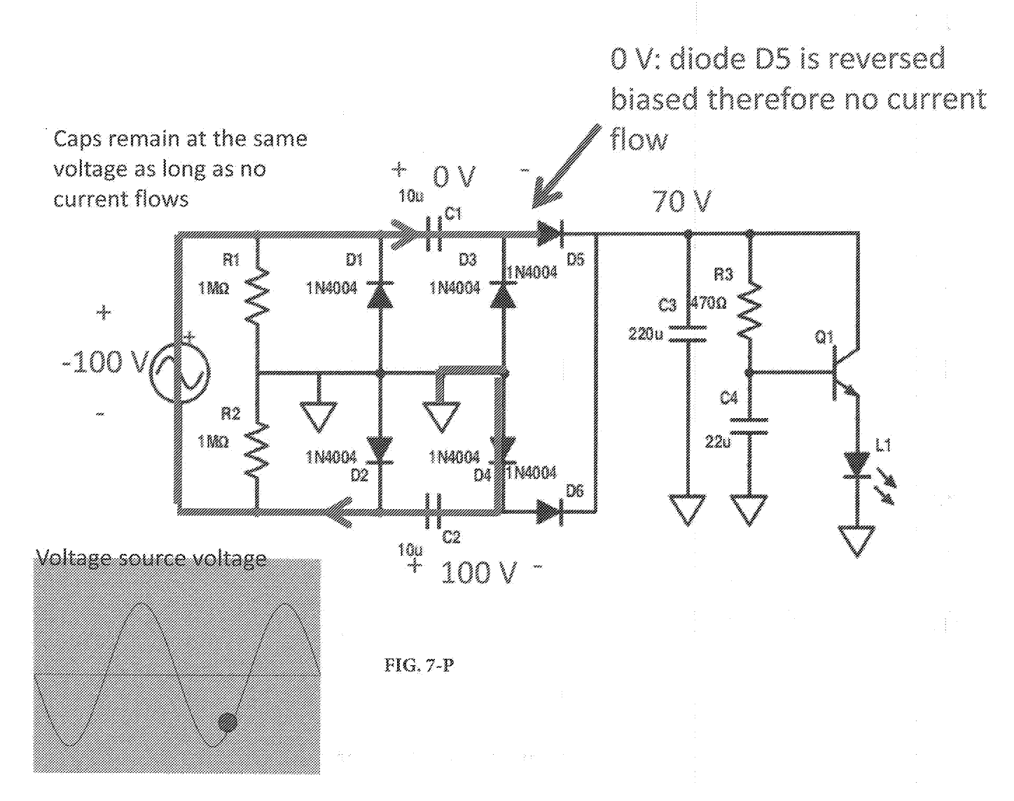

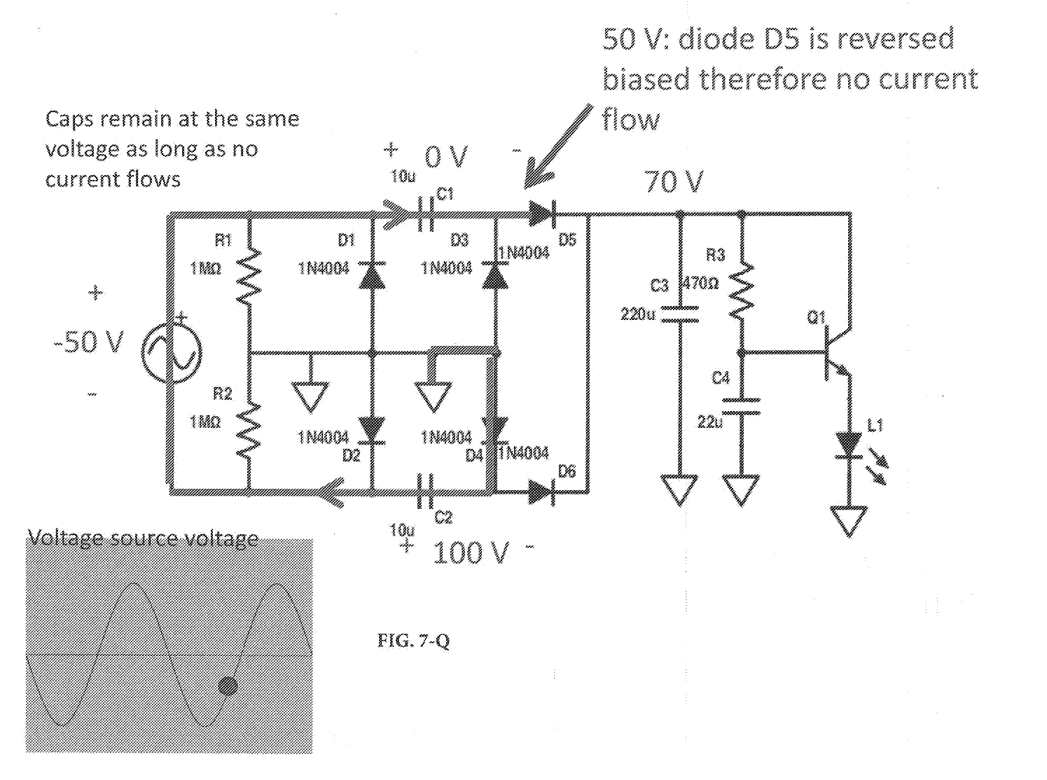

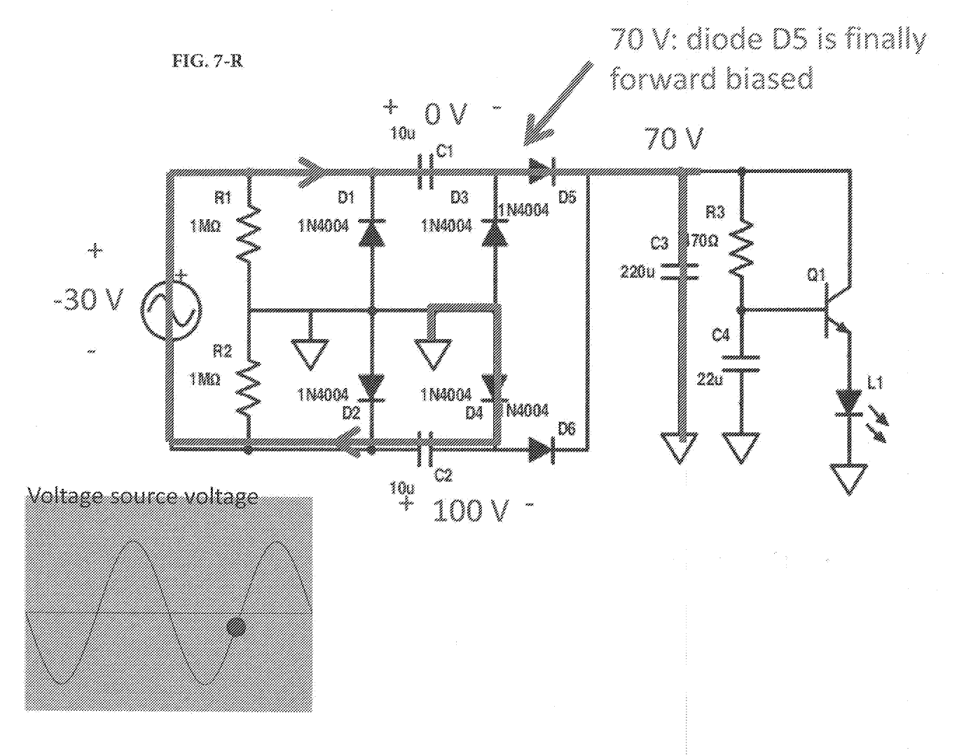

FIGS. 7-A-7-R illustrate steady-state signal flow of the example charge pump according to the present invention. FIGS. 7-A-7-F illustrate clock-wise steady-state current flow orientation as the phase of the voltage source increases from 270-360-90 degrees and dv/dt is positive across C1 and drives a voltage across C3 to 70 V. (FIGS. 7-O-7-R show flow from 270-360 degrees; FIGS. 7-A-7-F show flow from approximately 345-90 degrees). FIGS. 7-G-7-N illustrate counter-clock-wise steady-state current flow orientation of the example charge pump according to the present invention with counter-clock-wise current flow orientation as the phase of the voltage source increases from 90-180-270 degrees and dv/dt is positive across C1 and drives a voltage across C3 to 70 V.

FIGS. 7-A-7-F illustrate steady-state signal flow of the example charge pump according to the present invention with clock-wise current flow orientation as the phase of the voltage source increases from 270-360-90 degrees and dv/dt is positive across C1 and drives a voltage across C3 to 70 V, (See FIGS. 7-O-7-R to view the initial flow from 270-360 degrees; FIGS. 7-A-7-F show flow from approximately 345-90 degrees)

FIGS. 7-G-7-N illustrate steady-state signal flow of the example charge pump according to the present invention with counter-clock-wise current flow orientation as the phase of the voltage source increases from 90-180-270 degrees and dv/dt is positive across C1 and drives a voltage across C3 to 70 V.

Clock-wise steady-state flow orientation

FIG. 7-A illustrates a steady state signal flow of the example charge pump according to the present invention wherein the voltage source is at or about −30 V and three hundred thirty degree phase with an increasing voltage. C1 has a 0 V charge, C2 has a 100 V charge and storage capacitor C3 has a 70 V charge. There is a clockwise current due to the positive dv/dt across each of the voltage source and C1 and C2, and D5 is forward biased.

FIG. 7-B illustrates a steady state signal flow of the example charge pump according to the present invention wherein the voltage source is at or about 0 V and zero degree phase with an increasing voltage. C1 has a 15 V charge, C2 has a 85 V charge and storage capacitor C3 has a 70 V charge. There is a clockwise orientation of current due to the negative dv/dt across each of the voltage source and C1 and C2, and D5 is forward biased.

FIG. 7-C illustrates a steady state signal flow of the example charge pump according to the present invention wherein the voltage source is at or about 30 V and thirty degree phase with an increasing voltage. C1 has a 30 V charge, C2 has a 70 V charge and storage capacitor C3 has a 70 V charge. There is a clockwise orientation of current due to the negative dv/dt across each of the voltage source and C1 and C2, and D5 is forward biased.

FIG. 7-D illustrates a steady state signal flow of the example charge pump according to the present invention wherein the voltage source is at or about 60 V and sixty degree phase with an increasing voltage. C1 has a 44 V charge, C2 has a 54 V charge and storage capacitor C3 has a 70 V charge. There is a clockwise orientation of current due to the negative dv/dt across each of the voltage source and C1 and C2, and D5 is forward biased.

FIG. 7-E illustrates a steady state signal flow of the example charge pump according to the present invention wherein the voltage source is at or about 170 V and ninety degree phase with an increasing voltage. C1 has a 100 V charge, C2 has a 0 V charge and storage capacitor C3 has a 70 V charge. There is a clockwise orientation of current due to the negative dv/dt across each of the voltage source and C1 and C2, and D5 is forward biased.

FIG. 7-F illustrates a steady state signal flow of the example charge pump according to the present invention wherein the voltage source is at or about 170 V and ninety degree phase with an increasing voltage. C1 has a 100 V charge, C2 has a 0 V charge and storage capacitor C3 has a 70 V charge. There is a clockwise orientation of current due to the negative dv/dt across each of the voltage source and C1 and C2, and D5 is forward biased. D2 momentarily conducts to ensure C2 does not go negative.

Counter-clock-wise steady-state flow orientation

FIG. 7-G illustrates a steady state signal flow of the example charge pump according to the present invention wherein the voltage source is at or about 170 V and ninety degree phase with a decreasing voltage. C1 has a 100 V charge, C2 has a 0 V charge and storage capacitor C3 has a 70 V charge. There is a counter-clockwise orientation of current due to the negative dv/dt across each of the voltage source and C1 and C2, and D6 is reverse biased. Therefore, there is no current flow.

FIG. 7-H illustrates a steady state signal flow of the example charge pump according to the present invention wherein the voltage source is at or about 120 V and one hundred twenty degree phase with a decreasing voltage. C1 has a 100 V charge, C2 has a 0 V charge and storage capacitor C3 has a 70 V charge. There is a counter-clockwise orientation of current due to the negative dv/dt across each of the voltage source and C1 and C2, and D6 remains reverse biased.

FIG. 7-I illustrates a steady state signal flow of the example charge pump according to the present invention wherein the voltage source is at or about 70 V and one hundred thirty-five degree phase with a decreasing voltage. C1 has a 100 V charge, C2 has a 0 V charge and storage capacitor C3 has a 70 V charge. There is a counter-clockwise orientation of current due to the negative dv/dt across each of the voltage source and C1 and C2, and D6 remains reverse biased.

FIG. 7-J illustrates a steady state signal flow of the example charge pump according to the present invention wherein the voltage source is at or about 30 V and one hundred fifty degree phase with a decreasing voltage. C1 has a 100 V charge, C2 has a 0 V charge and storage capacitor C3 has a 70 V charge. There is a counter-clockwise orientation of current due to the negative dv/dt across each of the voltage source and C1 and C2, and D6 is forward biased.

FIG. 7-K illustrates a steady state signal flow of the example charge pump according to the present invention wherein the voltage source is at or about 0 V and one hundred eighty degree phase with a decreasing voltage. C1 has a 84 V charge, C2 has a 14 V charge and storage capacitor C3 has a 70 V charge. There is a counter-clockwise orientation of current due to the negative dv/dt across each of the voltage source and C1 and C2, and D6 is forward biased.

FIG. 7-L illustrates a steady state signal flow of the example charge pump according to the present invention wherein the voltage source is at or about −100 V and two hundred forty degree phase with a decreasing voltage. C1 has a 35 V charge, C2 has a 65 V charge and storage capacitor C3 has a 70 V charge. There is a counter-clockwise orientation of current due to the negative dv/dt across each of the voltage source and C1 and C2, and D6 is forward biased.

FIG. 7-M illustrates a steady state signal flow of the example charge pump according to the present invention wherein the voltage source is at or about −170 V and two hundred seventy degree phase with a decreasing voltage. C1 has a 0 V charge, C2 has a 100 V charge and storage capacitor C3 has a 70 V charge. There is a counter-clockwise orientation of current due to the negative dv/dt across each of the voltage source and C1 and C2, and D6 is forward biased.

FIG. 7-N illustrates a steady state signal flow of the example charge pump according to the present invention wherein the voltage source is at or about −170 V and two hundred seventy degree phase with a decreasing voltage. C1 has a 0 V charge, C2 has a 100 V charge and storage capacitor C3 has a 70 V charge. There is a counter-clockwise orientation of current due to the negative dv/dt across each of the voltage source and C1 and C2, and D6 is forward biased. D1 momentarily conducts to ensure C1 does not go negative.

Clock-wise steady-state flow orientation

FIG. 7-O illustrates a steady state signal flow of the example charge pump according to the present invention wherein the voltage source is at or about −170 V and two hundred seventy degree phase with an increasing voltage. C1 has a 0 V charge, C2 has a 100 V charge and storage capacitor C3 has a 70 V charge. There is a clockwise orientation of current due to the positive dv/dt across each of the voltage source and C1 and C2, and D5 is reverse biased.

FIG. 7-P illustrates a steady state signal flow of the example charge pump according to the present invention wherein the voltage source is at or about −100 V and three hundred degree phase with an increasing voltage. C1 has a 0 V charge, C2 has a 100 V charge and storage capacitor C3 has a 70 V charge. There is a clockwise orientation of current due to the positive dv/dt across each of the voltage source and C1 and C2, and D5 is reverse biased.

FIG. 7-Q illustrates a steady state signal flow of the example charge pump according to the present invention wherein the voltage source is at or about −50 V and three hundred fifteen degree phase with an increasing voltage. C1 has a 0 V charge, C2 has a 100 V charge and storage capacitor C3 has a 70 V charge. There is a clockwise orientation of current due to the positive dv/dt across each of the voltage source and C1 and C2, and D5 is reverse biased.

FIG. 7-R illustrates a steady state signal flow of the example charge pump according to the present invention wherein the voltage source is at or about −30 V and three hundred thirty degree phase with an increasing voltage. C1 has a 0 V charge, C2 has a 100 V charge and storage capacitor C3 has a 70 V charge. There is a clockwise orientation of current due to the positive dv/dt across each of the voltage source and C1 and C2, and D5 is forward biased.

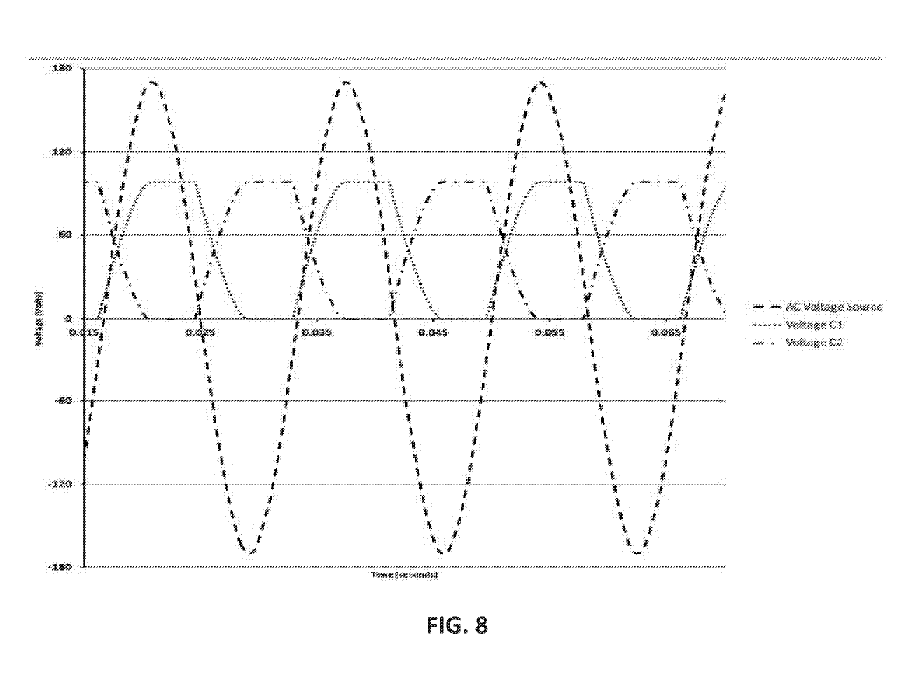

FIG. 8 shows an example A/C voltage source waveform and capacitor (C1, C2) waveforms for the charge pump.

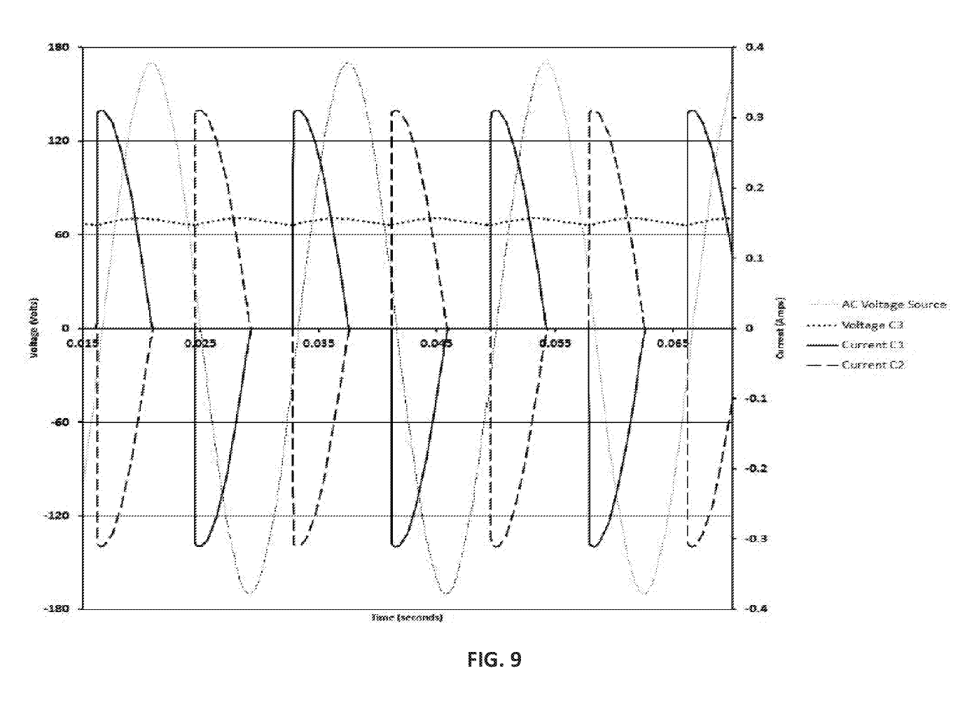

FIG. 9 shows an example A/C voltage source waveform, charge capacitor C3 voltage waveform, and current waveforms across C1, C2.

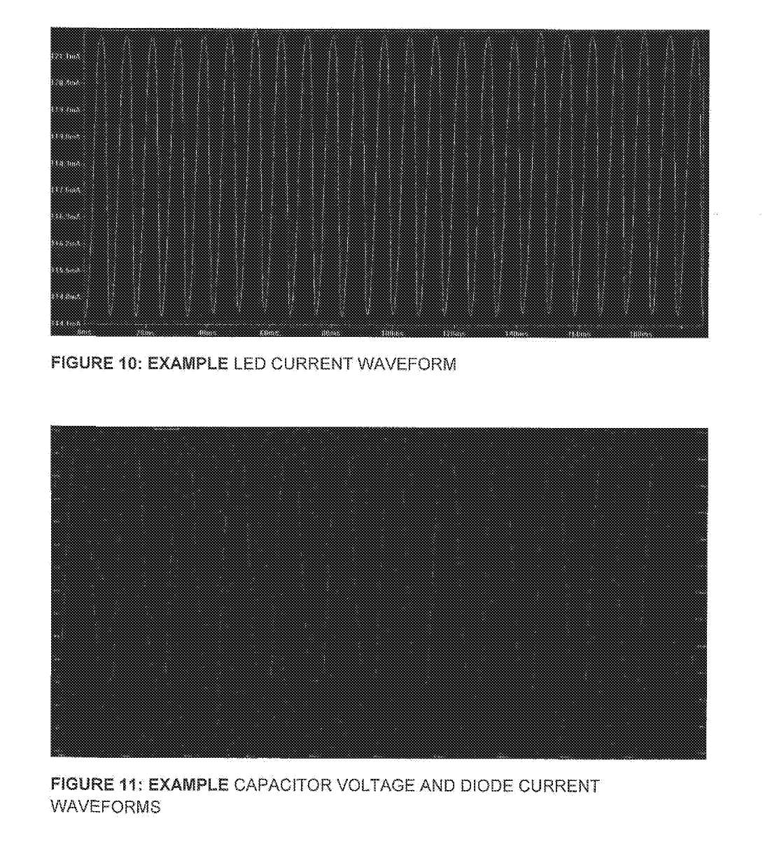

FIG. 10 shows an example LED current waveform.

FIG. 11 shows example capacitor voltage and diode current waveforms.

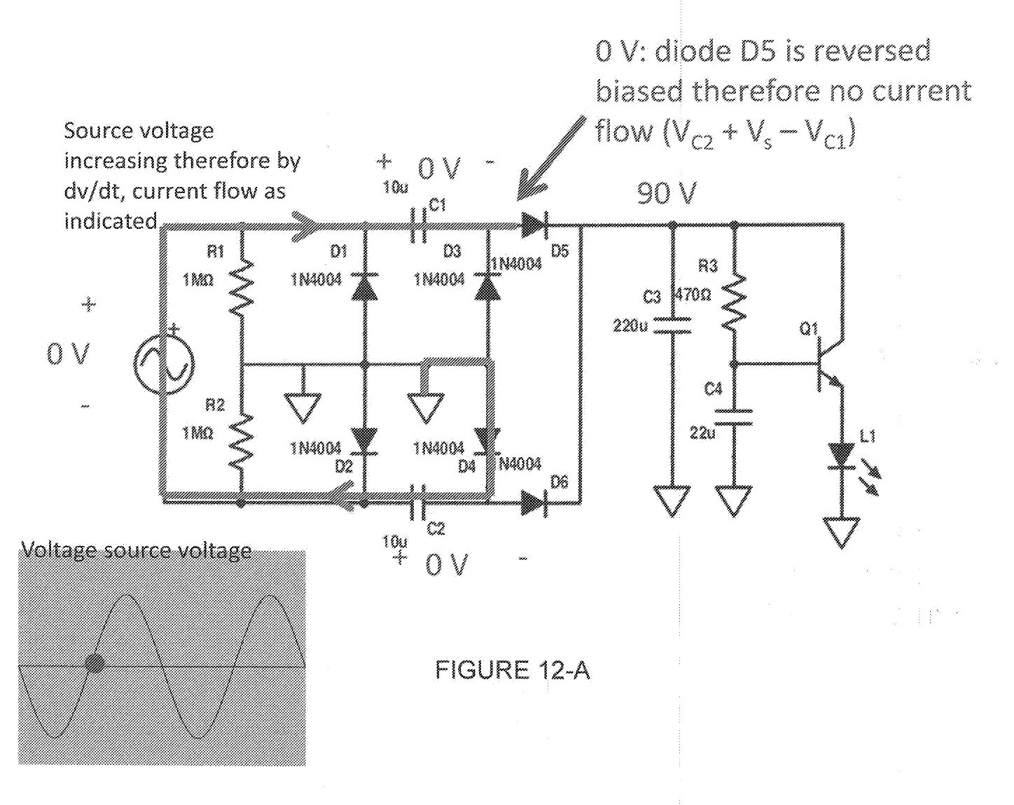

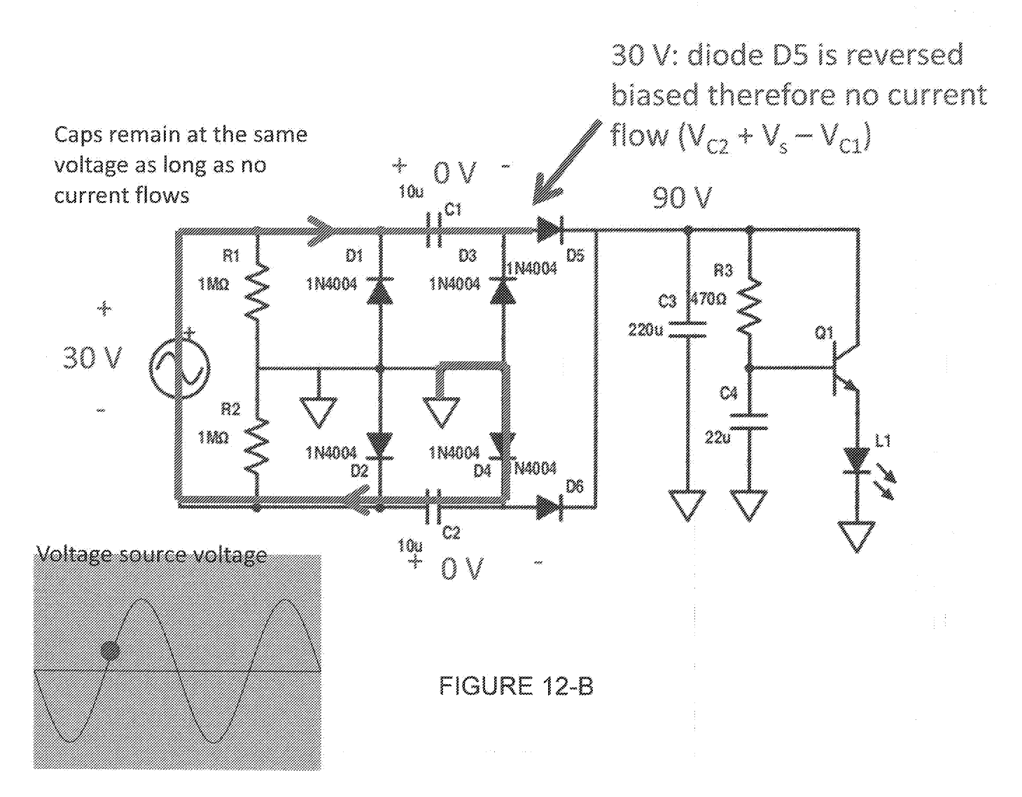

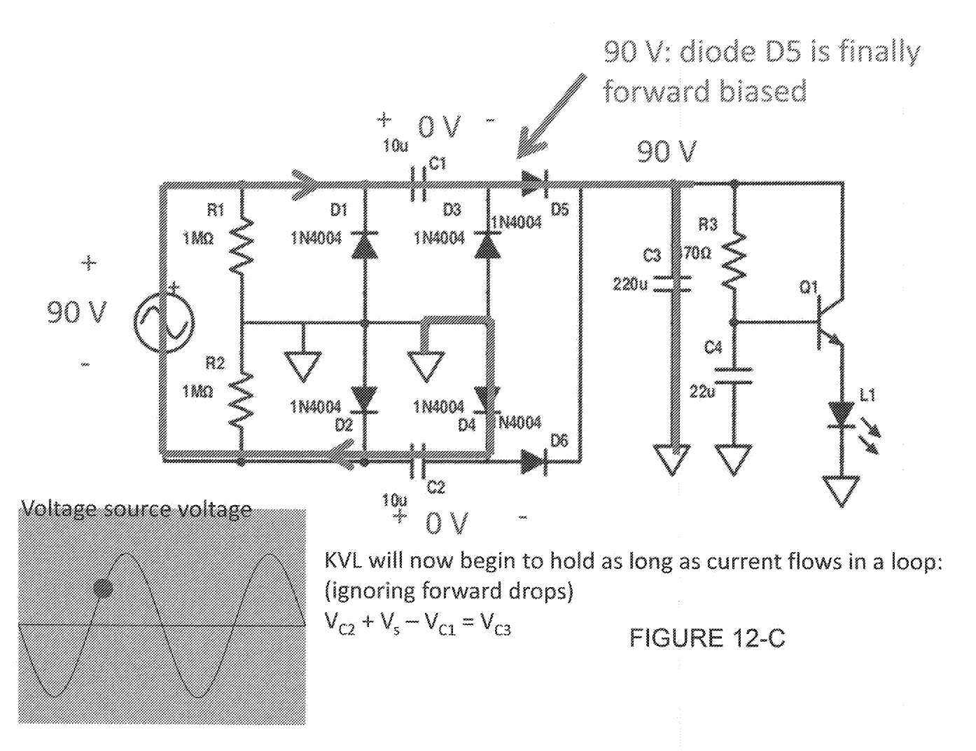

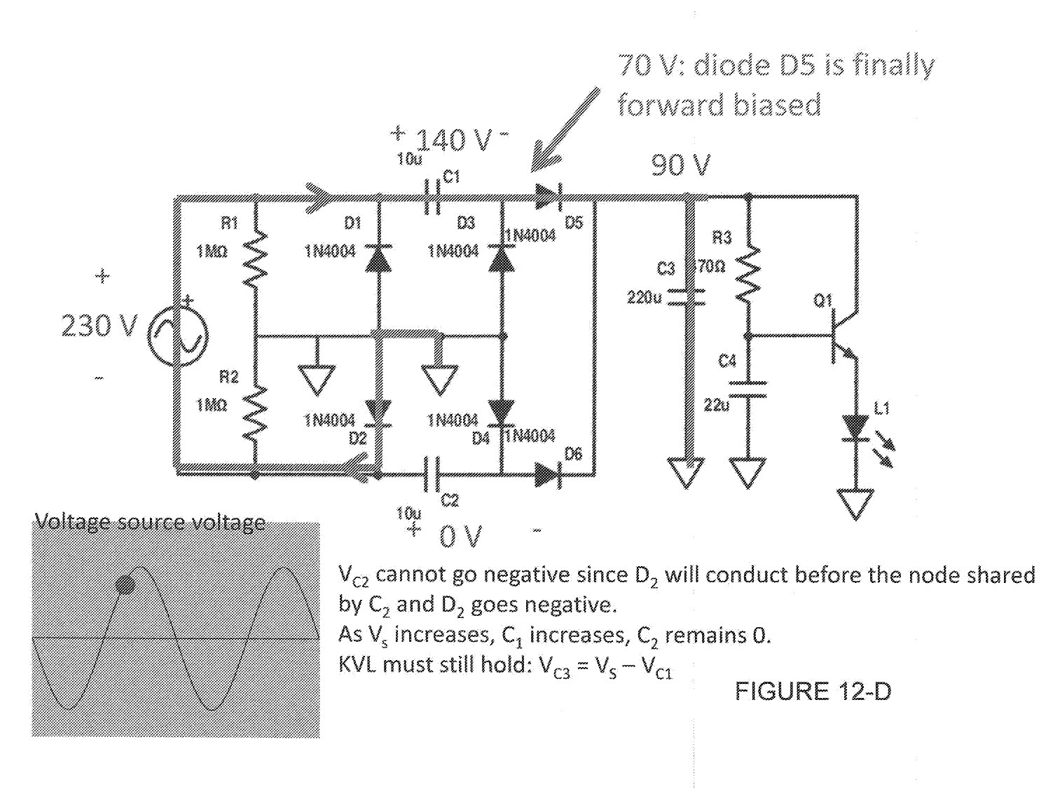

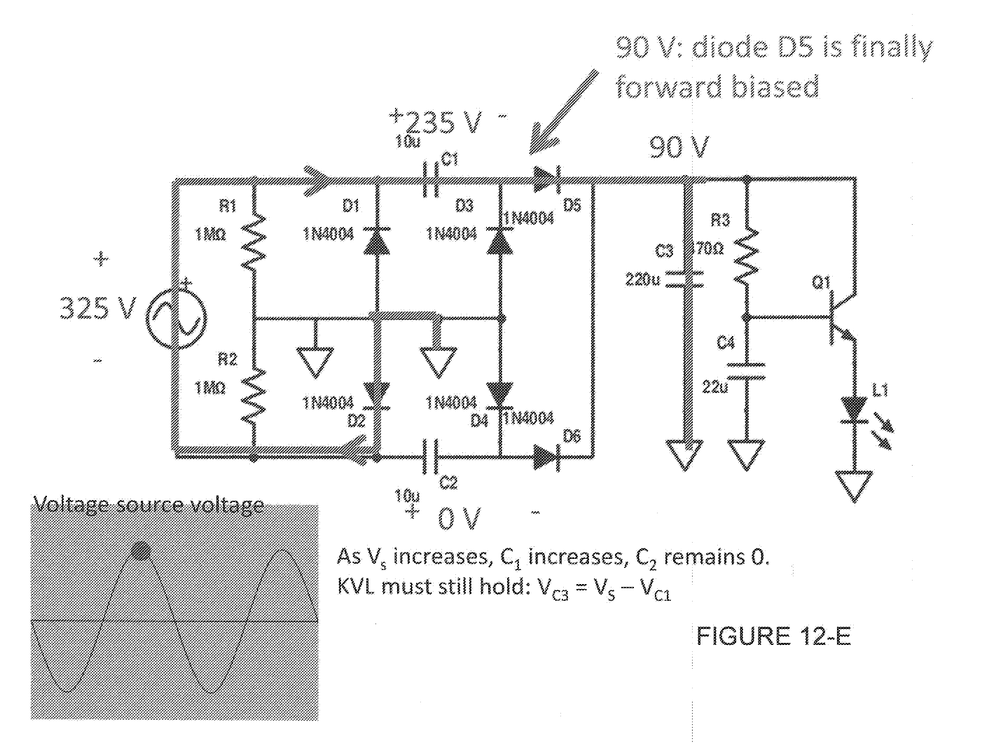

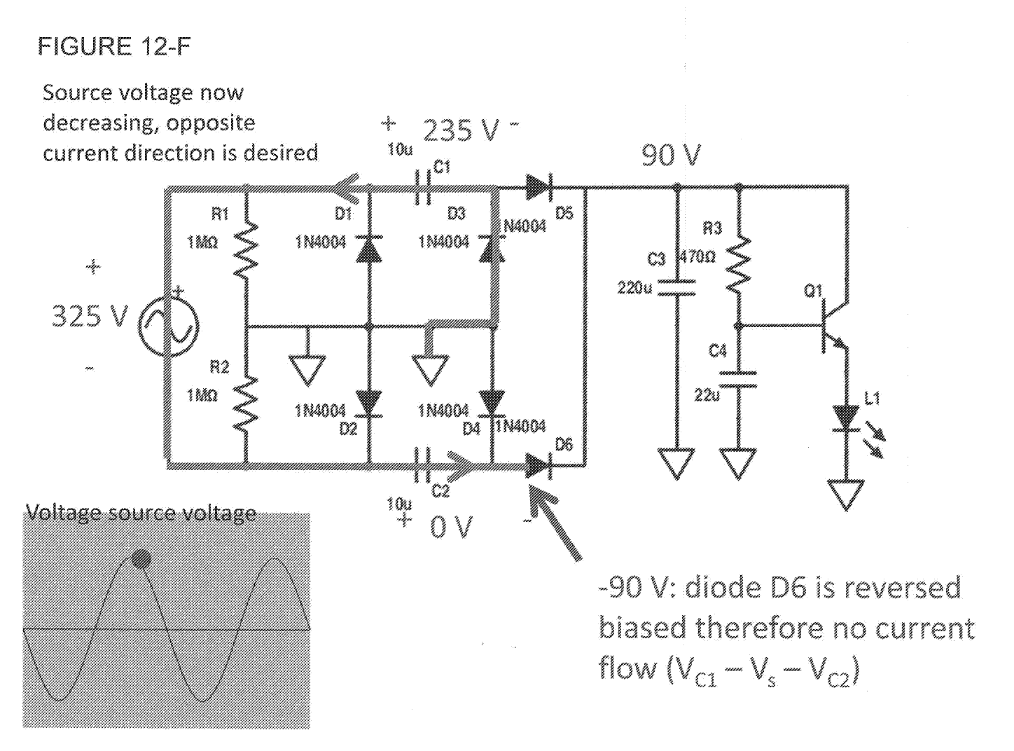

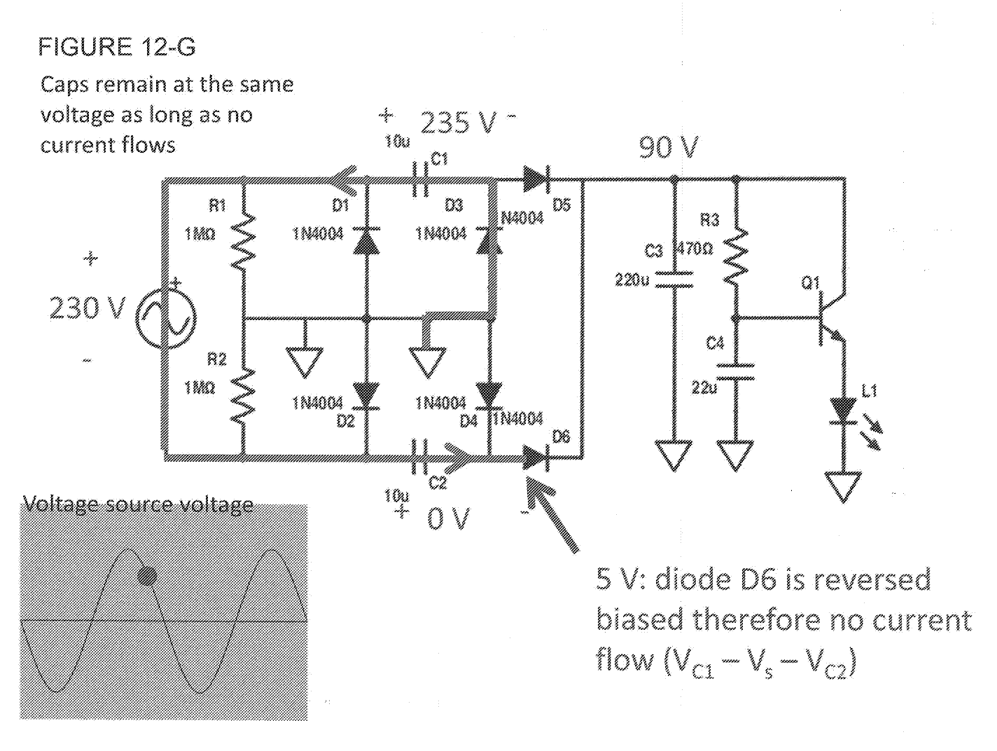

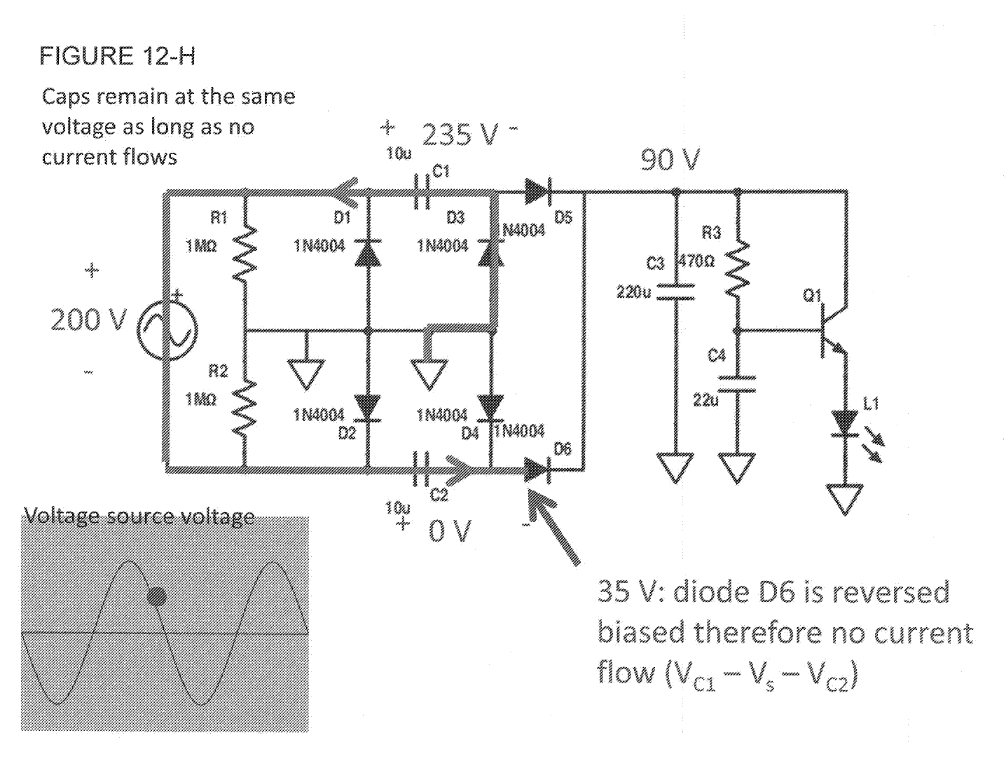

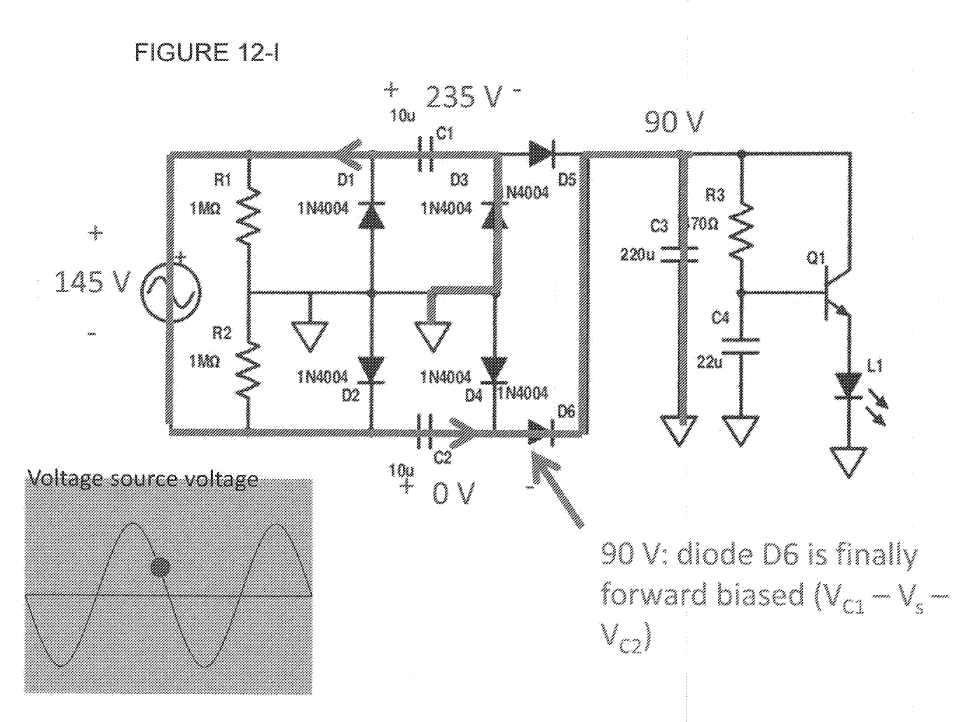

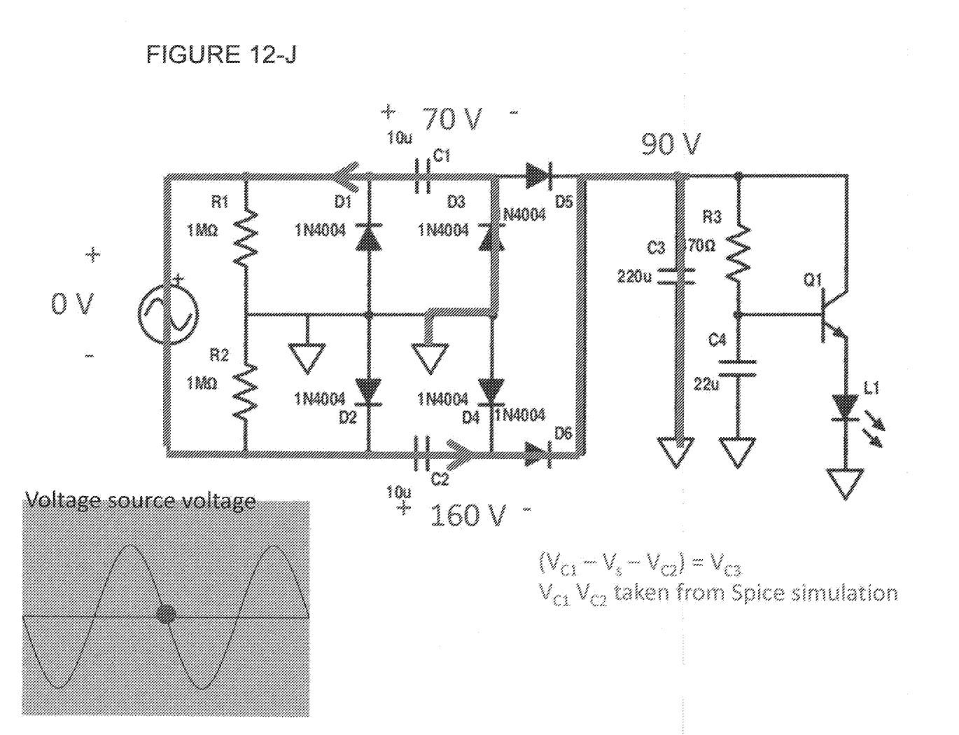

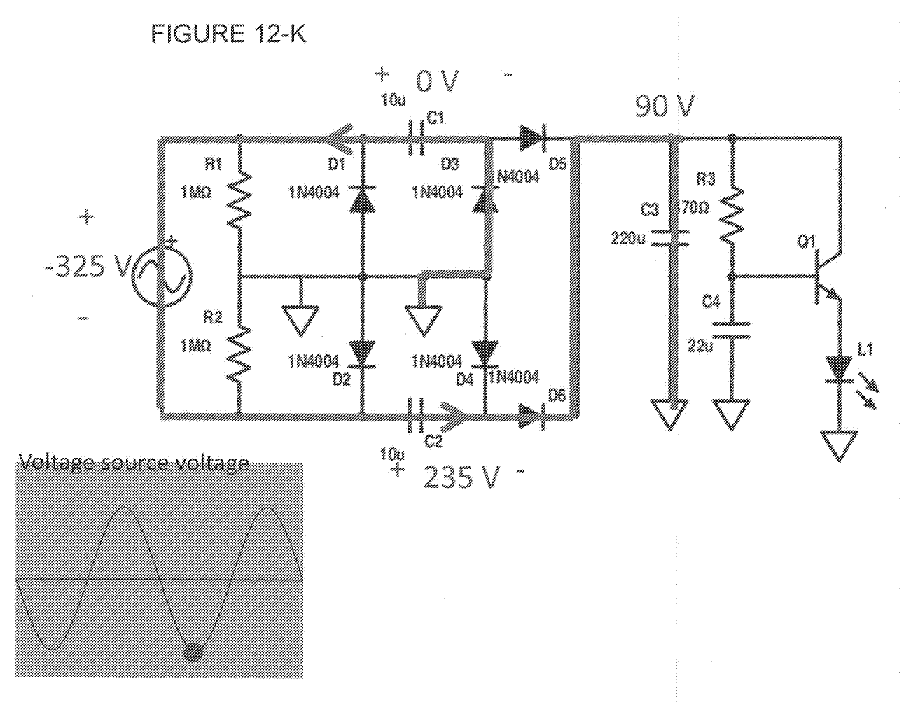

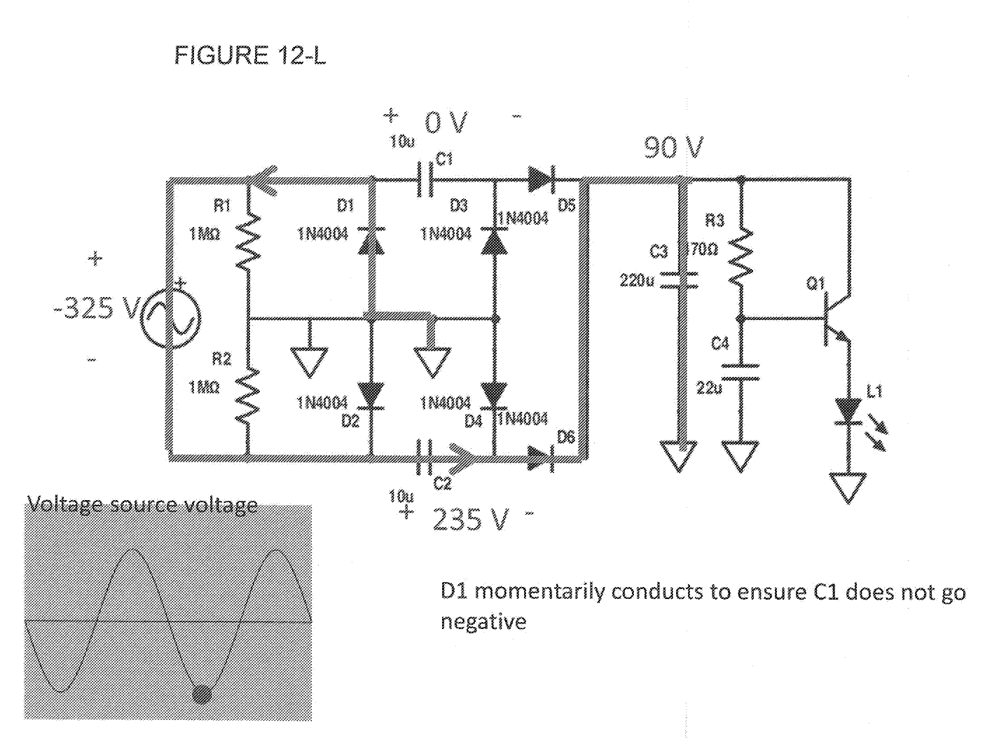

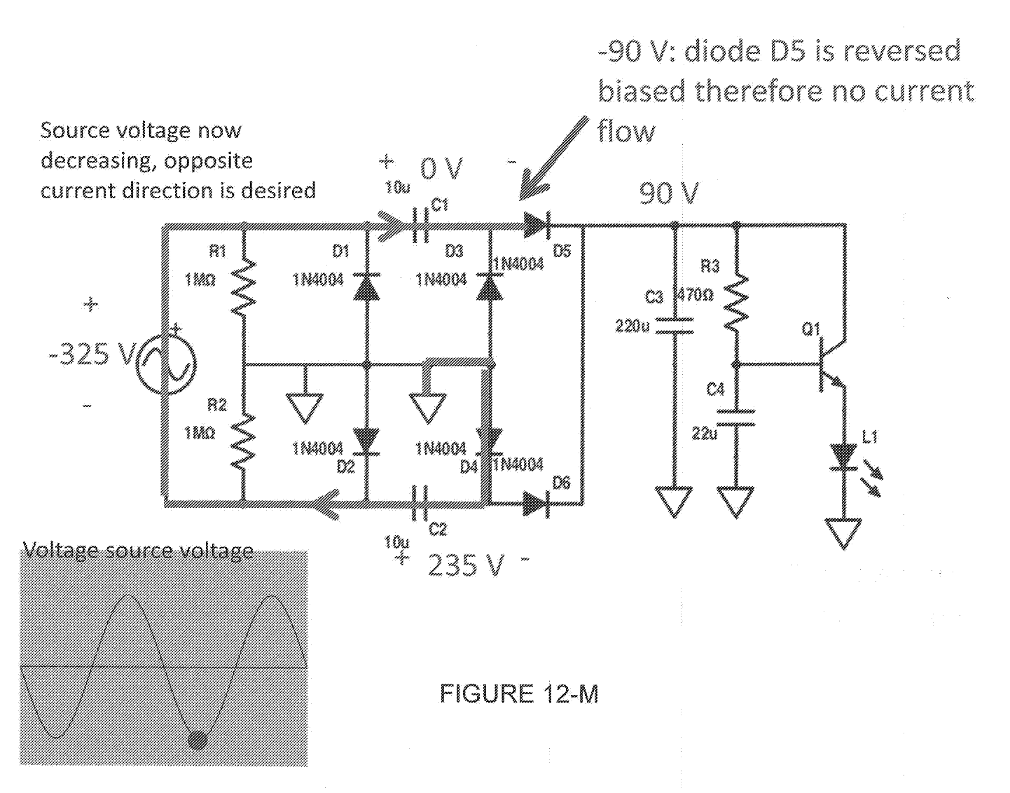

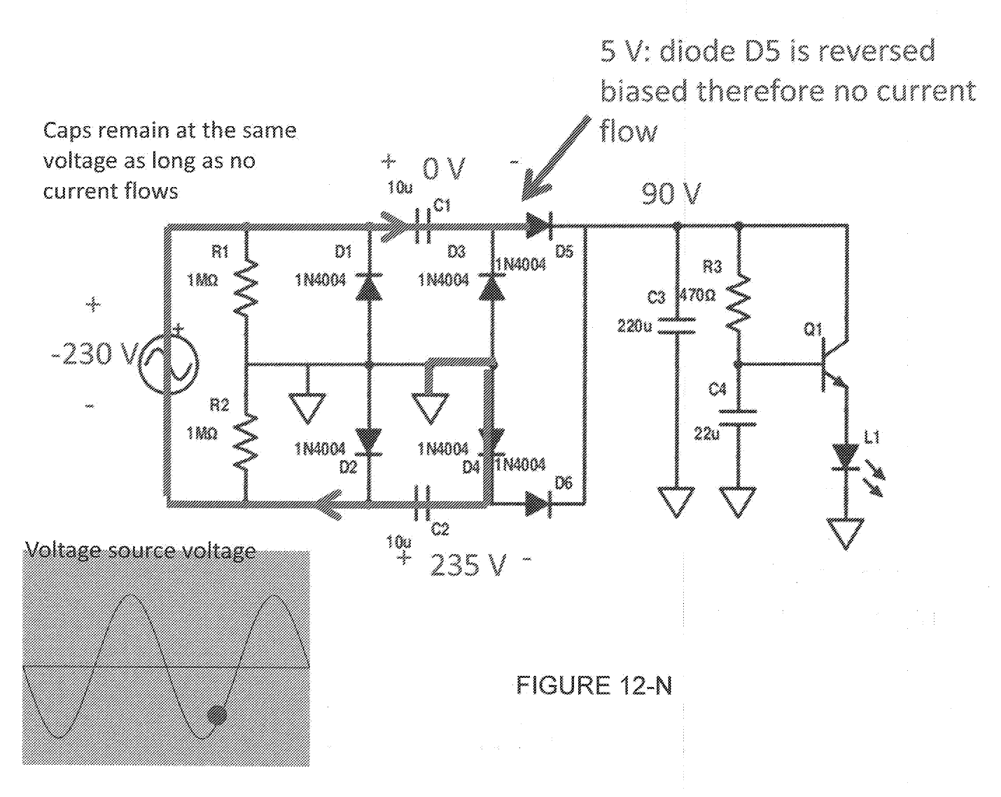

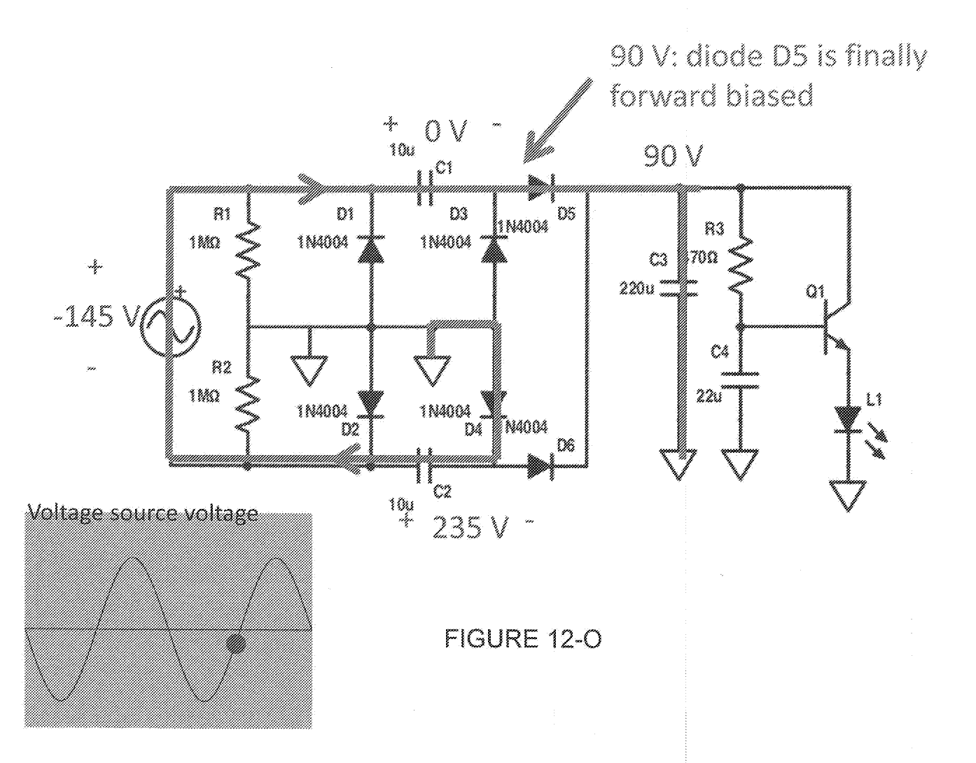

FIGS. 12-A-12-O illustrate transient signal flow of the example charge pump according to the present invention with an alternative example voltage source of 230 V RMS (325 V peak) at a cycle of 120 Hz.

FIGS. 12-A-12-E illustrate transient signal flow of the example charge pump according to the present invention with clock-wise current flow orientation as the phase of the voltage source increases from 0-90 degrees and dv/dt is positive across C1 and drives a voltage across C3 to 90 V.

FIGS. 12-F-12-L illustrate transient signal flow of the example charge pump according to the present invention with counter-clock-wise current flow orientation as the phase of the voltage source increases from 90-180-270 degrees and dv/dt is positive across C1 and drives a voltage across C3 to 90 V.

FIGS. 12-M-12-O illustrate transient signal flow of the example charge pump according to the present invention with clock-wise current flow orientation as the phase of the voltage source increases from 270-360 degrees and dv/dt is positive across C1 and drives a voltage across C3 to 90 V.

Further, as described herein, the various features have been provided in the context of various described embodiments, but may be used in other embodiments. The combinations of features described herein should not be interpreted to be limiting, and the features herein may be used in any working combination or sub-combination according to the invention. The values for resistances and capacitances are exemplar in nature; various other values may be selected in order to achieve comparable results. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. An inductor-less LED power pump including a pair of circuit paths, a first path for driving a voltage charge through a first capacitor to a charge capacitor during a first phase of a cycle from an alternating current power source and a second path for driving a voltage charge through a second capacitor to the charge capacitor during a second phase of the cycle.

2. The inductor-less LED power pump of claim 1, the power pump comprising a dual input, each input connecting to respective of the paths and a first capacitor node of a respective capacitor, a second capacitor node of each capacitor connecting to a pair of diodes, a first of the diodes opposing current flow in a first direction and the second of the diodes passing current flow in the first direction to an output of the power pump.

3. The inductor-less LED power pump of claim 2, the output of the power pump comprising an output node connecting to one terminal of the charge capacitor, a second terminal of the charge capacitor connecting to a ground.

4. The inductor-less LED power pump of claim 3, the output node further connecting to the current driver circuit.

5. An inductor-less light emitting diode (LED) power supply apparatus including:
(a) an inductor-less power pump operable to receive a signal from an alternating power supply and to maintain a substantially fixed voltage across one or more LEDs; and
(b) a current driver.

6. The inductor-less LED power supply apparatus of claim 5, the power pump comprising a dual input, each input connecting to a first capacitor node of a respective capacitor, a second capacitor node of each capacitor connecting to a pair of diodes, a first of the diodes opposing current flow in a first direction and the second of the diodes passing current flow in the first direction to an output of the power pump.

7. The inductor-less LED power supply apparatus of claim 5, the output of the power pump comprising an output node connecting to one terminal of a third capacitor, a second terminal of the third capacitor connecting to a ground.

8. The inductor-less LED power supply apparatus of claim 7, the output node further connecting to the current driver circuit.

9. The inductor-less LED power supply apparatus of claim 5, the alternating power supply comprising 120 Vrms and 60 Hz.

10. The inductor-less LED power supply apparatus of claim 9, the substantially fixed voltage comprising 70 Vdc.

11. An inductor-less method for supplying power to an LED including
receiving an alternating incoming power supply signal through dual input terminals of an inductor-less charge pump;
outputting an alternating charge pump signal through a single output terminal of the inductor-less charge pump; and
charging a supply capacitor through the single output terminal of the inductor-less power pump, the supply capacitor operable to supply a substantially constant voltage across one or more LEDs.

12. The inductor-less method of claim 11 including:
charging the supply capacitor through two branches of the inductor-less power pump, the first branch charging the supply capacitor during an increasing value supplied by the power supply signal, the second branch charging the supply capacitor during a decreasing value supplied by the power supply signal.

13. The inductor-less method of claim 12, the increasing value and decreasing value comprising voltages.

14. The inductor-less method of claim 12 including:
increasing the increasing value during a first half of an alternating current cycle; and
decreasing the decreasing value during a second half of the alternating current cycle.

15. The inductor-less method of claim 11 including:
maintaining a charge over the supply capacitor by alternately delivering power to the supply capacitor through respective of two branches of the inductor-less power pump, the first branch driving charge to the supply capacitor during an increasing value supplied by the power supply signal, the second branch driving charge to the supply capacitor during a decreasing value supplied by the power supply signal.

16. The inductor-less method of claim 11, the increasing value and decreasing value comprising voltages.

17. The inductor-less method of claim 16, increasing the increasing value during a first half of an alternating current cycle; decreasing the decreasing value during a second half of the alternating current cycle.
